(19) United States
(12) Patent Application Publication
(10) Pub. No.: US 2013/0006769 A1
(43) Pub. Date: Jan. 3, 2013

(54) Criteria-Based Audio Messaging In Vehicles

(76) Inventors: Thomas Barton Schalk, Plano, TX (US); Steven Deeb, Rowley, MA (US); Tod Farrell, Coppell, TX (US); Kirill Izotov, Acton, MA (US)

(21) Appl. No.: 13/524,819

(22) Filed: Jun. 15, 2012

Related U.S. Application Data
(63) Continuation-in-part of application No. 12/541,496, filed on Aug. 14, 2009.
Application No. 12/541,496 is a continuation-in-part of application No. 12/363,267, filed on Jan. 30, 2009.
Application No. 12/363,267 is a continuation-in-part of application No. 13/033,046, filed on Feb. 23, 2011.
Application No. 13/033,046 is a division of application No. 12/363,267, filed on Jan. 30, 2009.
Application No. 12/363,267 is a continuation-in-part of application No. 13/033,083, filed on Feb. 23, 2011.
Application No. 13/033,083 is a division of application No. 12/363,267, filed on Jan. 30, 2009.
Application No. 12/363,267 is a continuation-in-part of application No. 13/033,112, filed on Feb. 23, 2011.
Application No. 13/033,112 is a division of application No. 12/363,267, filed on Jan. 30, 2009.
Application No. 12/363,267 is a continuation-in-part of application No. 13/033,167, filed on Feb. 23, 2011.
Application No. 13/033,167 is a division of application No. 12/363,267, filed on Jan. 30, 2009.
Application No. 12/363,267 is a continuation-in-part of application No. 13/033,185, filed on Feb. 23, 2011.
Application No. 13/033,185 is a division of application No. 12/363,267, filed on Jan. 30, 2009.
(60) Provisional application No. 61/497,849, filed on Jun. 16, 2011.
(60) Provisional application No. 61/497,768, filed on Jun. 16, 2011.
(60) Provisional application No. 61/089,148, filed on Aug. 15, 2008.
(60) Provisional application No. 61/024,956, filed on Jan. 31, 2008.

(51) Int. Cl. G06Q 30/02

(52) U.S. Cl. 705/14.54; 705/14.62; 705/14.61; 705/14.53

(57) ABSTRACT

A method for providing marketing materials from a marketing and information service platform to a vehicle telematics system comprises the steps of receiving route information at an integral telematics system of a vehicle and delivering personalized messages to the telematics system for transmission to a user of the vehicle based on at least one of location and pre-defined preference information corresponding to the route information. A method for providing marketing materials from a marketing and information services platform to a vehicle telematics system comprises the steps of sending route information from the vehicle telematics system integral with a vehicle to the marketing and information service platform remote from the vehicle and receiving personalized messages at the vehicle telematics system from the marketing and information service platform based on at least one of location and pre-defined preference information corresponding to the route information.

### CROSS-REFERENCE TO RELATED APPLICATION

This application claims the priority, under 35 U.S.C. §119, of co-pending
U.S. Provisional Patent Application Ser. No. 61/497,849, filed Jun. 16, 2011; and
U.S. Provisional Patent Application Ser. No. 61/497,768, filed Jun. 16, 2011 [Atty Docket: Agero/Custom Content],
   the prior applications are herewith incorporated by reference herein in their entireties.

This application is:
a continuation-in-part of U.S. patent application Ser. No. 12/541,496 [Atty. Docket: Agero/Criteria], filed Aug. 14, 2009 (which application claims the priority, under 35 U.S.C. § 119, of U.S. Provisional Application No. 61/089,148, filed on Aug. 15, 2008);
a continuation-in-part application of U.S. patent application Ser. No. 12/363,267 [Atty. Docket: ATX/Bluetooth], filed Jan. 30, 2009 (which application claims the priority, under 35 U.S.C. §119, of U.S. Provisional Patent Application Ser. No. 61/024,956, filed Jan. 31, 2008);
a continuation-in-part application of U.S. patent application Ser. No. 13/033,046, filed Feb. 23, 2011 [Atty. Docket Agero/Bluetooth DIV1], which is a divisional application of U.S. Patent Application Serial No. 12/363,267;
a continuation-in-part application of U.S. patent application Ser. No. 13/033,083, filed Feb. 23, 2011 [Atty. Docket Agero/Bluetooth DIV2], which is a divisional application of U.S. patent application Ser. No. 12/363,267;
a continuation-in-part application of U.S. patent application Ser. No. 13/033,112, filed Feb. 23, 2011 [Atty. Docket Agero/Bluetooth DIV3], which is a divisional application of U.S. patent application Ser. No. 12/363,267;
a continuation-in-part application of U.S. patent application Ser. No. 13/033,167, filed Feb. 23, 2011 [Atty. Docket Agero/Bluetooth DIV4], which is a divisional application of U.S. patent application Ser. No. 12/363,267; and
a continuation-in-part application of U.S. patent application Ser. No. 13/033,185, filed Feb. 23, 2011 [Atty. Docket Agero/Bluetooth DIVS^{.}], which is a divisional application of U.S. patent application Ser. No. 12/363,267,
   the latter five applications are divisional applications of the second application in the above list and are divisional applications of one another, and the entire disclosures of all of the above-listed applications are hereby incorporated herein by reference in their entireties.

### FIELD OF THE INVENTION

The present disclosure pertains to a method of delivering audio messages through a wireless connection to a vehicle. More particularly, the present disclosure pertains to a method of delivering audio messages that are triggered by criteria related to, for example, time, vehicle location, an event, a condition, mood-influencing intent, a tourist attraction, a user action, service reminders, and many more. The criteria-based messages are controlled by an automated voice-recognition system located at a remote data center and delivered through a wireless voice or data channel to the vehicle. The vehicle driver hears the audio message under various driving conditions. A voice user interface can be utilized by the vehicle driver to manage the audio messages.

### BACKGROUND OF THE INVENTION

Constant changes in culture and technology provide an ever-increasing array of avenues for one to reach customers or potential customers. These include, for example, television, radio, magazines, direct mail, signage, the Internet, including standard and interactive social websites, and mobile devices, which are providing more and more connectivity to the previously mentioned channels of communication.

Not long ago, the advertising industry was limited to substantially less media channels from which to choose. However, over time, advertisers have taken advantage of each new media channel option as it has developed. These new channels are now quite numerous and advertising strategies have become more creative than ever. The growing number of media channels can be attributed mainly to the above-mentioned advances in communication technology, including, for instance, better and more abundant access to information deliverable over the Internet, such as 3G mobile devices.

In addition, with geographic location determining features, such as the global positioning systems (GPS), included in advanced mobile devices, the mobile device medium has the potential to provide marketers with the ability to target customers based on their geographic location and also to utilize imaging. Although, multimedia advertisements (i.e., including visual components) have become a dominant message format, such a format is usually not appropriate for a vehicle driver from a safety perspective.

Because the average person spends a substantial amount of time in their vehicle, the automobile is a highly desirable media channel for delivering advertising. However, there are challenges with the user interface under driving conditions, especially because images displayed in the vehicle can distract the driver. Before trying to push advertising messages to the vehicle, one must understand the task of driving and know that safety is a high priority. Driving is so basic to modern life that drivers no longer think of it as a complex task. However, driving requires constant focus as well as a vast amount of physical coordination and analytical skills In addition, the cognitive load of driving has increased over time. Increasing traffic levels, complex mixes of road systems (often subject to construction or constriction), and a much higher flow of information and infotainment to the vehicle make ordinary driving a very demanding challenge. Physically, every part of the body is involved in driving. Even today's most advanced vehicles still require hands on the wheel and feet ready for the accelerator and brake pedal.

With technological advances, driving is still largely a silent activity when it comes to tools and controls. Speech is not always an easy interface to use, especially in an automotive environment when others in the car are talking. If a car has a speech input, it is usually an optional interface mode because there can be technical challenges when trying to automatically recognize a driver or passenger's speech in a hands-free automotive environment.

There are two main modes of communicating information to a vehicle driver: auditory and visual. Over a brief period of time (e.g., a few minutes), humans can perceive much more information through vision than through hearing. However, the driver of a vehicle must apply visual concentration on driving and driver distraction must be minimized.

Therefore, a need exists to overcome the problems with the prior art as discussed above.

### SUMMARY OF THE INVENTION

Disclosed herein are systems, methods, and processes of delivering criteria-based audio messages from a remote data center database over a wireless link. The information delivered can be in the form of a short audio clip that is crafted carefully to give the desired effect on the vehicle driver. Exemplary embodiments of the messages are designed to be non-intrusive with a strong personality associated with the voices contained in the recordings. Such highly personified human recordings are triggered (initiated) based on one or a combination of different criteria including, but not limited to time, vehicle location, an event, a condition, a mood-influencing intent, a tourist attraction, or service reminders. An automated voice system located at the remote data center generates the audio messages.

A significant aspect disclosed here is that, in the audio domain, a service example can be more effective than a service description. After hearing a service example, people think of numerous other ways they could use the service. Analogous use cases are imagined in the driver's mind. The persona alone can influence mood. For example, imagine hearing a service demonstration portrayed by a combination of a male agent speaking to a female driver in a highly staged fashion. The service examples involve professional actors with voice characteristics that qualify them to be recording artists, which combines with the ability to speak quickly, clearly, and in a way that matches the goal of the scenario being acted out. The style of prompting used to describe a service is different from the style of prompting when acting out service example scenarios. For service examples, it is easier and more appropriate to exaggerate behavior, rather than remain somewhat monotonous, as is the case with service descriptions. Finally, the inventors' testing with human subjects clearly indicates that service examples, as described here, are far more effective than service descriptions in the context of influencing mood to buy while driving.

Flexibility is critical to delivering effective, up-to-date audio messages to vehicle drivers. All of the message recordings are conducted outside of the vehicle, typically at professional recording studios. The recordings are edited and concatenated in ways that enhance the affect on the driver and minimize driver distraction. For example, the messages should be short and to the point (less than 15 seconds, depending on the intent and scenario). In some cases, the driver requests to hear a service example (e.g., an acted out interaction between an agent and a driver) and, through a voice interface, the driver can elect to hear more or to stop the message at anytime.

It would be a significant advancement in the art to implement an automatic voice recognition system at a remote data center that would deliver audio messages from an off-board database over a wireless link to the vehicle driver in a hands-free environment. The primary advantages of the remote data center are flexibility and cost effectiveness. Because the platform is off-board, the application and message content can easily be modified without changing any in-vehicle hardware, or software. In terms of cost, server-based voice recognition resources can be shared across a large spectrum of different vehicles. For example, each channel of server-based voice-automation system could accommodate several vehicles simultaneously.

Locating the automated voice system at the remote data center provides substantial advantages over an embedded system inside the vehicle. The advantages include:
Increased operational flexibility and control from the call center;
Increased efficiency, since content can be added or modified with centralized hardware and/or software;
Improved scalability, since computer resources are shared across a large number of vehicles;
Usability improvement, to the extent that calls from the vehicles can be monitored and improvements made at the centralized location, rather than in the vehicles;
A “thin” client can be located in the vehicle using standard telematics control units, rather than a specialized on-board computer; and
The ability to connect a vehicle driver to a human agent that is able to activate a new service specific to the vehicle.

Wireless delivery of audio messages can also help automobile manufacturers and dealerships promote a vehicle's value-added features that often go unnoticed and unused by its owner. Because of the off-board implementation, content can be modified to highlight features the automobile manufacturer would like to promote. For that matter, recall notification could be managed efficiently through criteria related to remote diagnostics of the vehicle provided through telematics.

With the foregoing and other objects in view, there is provided, a method for delivering a criteria-based message to a vehicle occupant, where the method includes establishing a wireless communication session between a mobile device integral with a vehicle and a data center remote from the vehicle. Next, an identifier of the vehicle and at least one criteria from the mobile device is communicated to the remote data center. The at least one criteria includes a statistic of the vehicle and/or a statistic of a user of the mobile device. Based on the at least one criteria, an advertisement message for communication to the mobile device is determined. Then, the determined advertisement message is communicated from the remote data center to the mobile device. In a further step, the advertisement message is output with a speaker fixed within the vehicle carrying the mobile device. As used herein, a statistic is used in its most broadest sense as an item of information or data. It is not limited to a collection of data or to a numerical function used to describe a sample.

In accordance with another mode, the advertisement message includes a service example and/or a service description.

In accordance with a further mode, the service example includes a pre-recorded dialogue between at least two persons, the dialogue providing information pertaining to features of a product and/or a service.

In accordance with an added mode, the service example mimics a live service interaction between a vehicle driver and a remote data center human agent.

In accordance with an additional mode, the at least one criteria includes a time of day, a time of year, and/or a season.

In accordance with yet a further mode, the at least one criteria includes a task progress, a scheduled event, a geographic location of the vehicle, and a condition of the vehicle.

In accordance with again a further mode, the method further includes the steps of accepting an interrupt command from the mobile device, halting the output of the advertisement message in response to accepting the interrupt command, and initiating a driver assist query.

In accordance with yet a further feature, the establishing a wireless communication is initiated by a telematics request.

With the foregoing and other objects in view, there is provided, in accordance with the invention, a method for providing marketing materials from a marketing and information service platform to a vehicle telematics system comprising the steps of receiving route information at an integral telematics system of a vehicle and delivering personalized messages to the telematics system for transmission to a user of the vehicle based on at least one of location and pre-defined preference information corresponding to the route information.

With the objects of the invention in view, there is also provided a method for providing marketing materials from a marketing and information services platform to a vehicle telematics system comprising the steps of sending route information from the vehicle telematics system integral with a vehicle to the marketing and information service platform remote from the vehicle and receiving personalized messages at the vehicle telematics system from the marketing and information service platform based on at least one of location and pre-defined preference information corresponding to the route information.

In accordance with another mode of the invention, the personalized messages are delivered or received based upon a time of day.

In accordance with a further mode of the invention, the route information comprises current global positioning system (GPS) coordinates identified by a GPS component of the telematics system.

In accordance with an added mode of the invention, the personalized messages are delivered or received through a pre-selected mode of communication.

In accordance with an additional mode of the invention, the personalized messages are aggregated.

In accordance with yet another mode of the invention, the personalized messages are delivered based on an assigned relevancy.

In accordance with yet a further mode of the invention, the personalized messages are sent or received based upon a user permission setting.

In accordance with yet an added mode of the invention, the personalized messages are based upon social networking application data.

In accordance with yet an additional mode of the invention, the personalized messages are dynamically calculated.

In accordance with again another mode of the invention, the personalized messages are modified on the fly through direct in-vehicle customer feedback.

In accordance with again a further mode of the invention, the personalized messages are presented based on a history of requested point of interest searches.

In accordance with again an added mode of the invention, direct in-vehicle customer feedback is sent to the marketing and information services platform.

In accordance with again an additional mode of the invention, the route information is sent to the marketing and information services platform via a cellular network.

In accordance with a concomitant mode of the invention, the personalized messages are received via at least one of a cellular network and the Internet.

Other characteristic features are set forth in the appended claims.

Although the invention is illustrated and described herein as embodied in systems, methods, and processes of delivering criteria-based audio messages from a remote data center database over a wireless link, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

Advantages of embodiments of the present invention will be apparent from the following detailed description of the preferred embodiments thereof, which description should be considered in conjunction with the accompanying drawings in which:

FIG. 1 is a block diagram of an exemplary embodiment of a mobile communication system;

FIG. 2 is a block diagram of an exemplary embodiment of a control center;

FIG. 3 is a flow diagram illustrating an exemplary process for providing service management;

FIG. 4 is a block diagram of an exemplary embodiment of a control center having an order management system;

FIG. 5 is a flow diagram illustrating an exemplary process of creating an order for sequential business transactions;

FIGS. 6 to 8 are exemplary order processing worksheets for use with the process of creating an order for sequential business transactions in accordance with an exemplary embodiment;

FIG. 9 is diagrammatic representation of a telematics and marking system in accordance with an exemplary embodiment;

FIG. 10 is a diagrammatic representation of a system and process in accordance with another exemplary embodiment;

FIG. 11 is another diagrammatic representation of a system and process in accordance with yet another exemplary embodiment;

FIG. 12 is another diagrammatic representation of a system and process in accordance with yet a further exemplary embodiment;

FIG. 13 is another diagrammatic representation of a system and process in accordance with yet an added exemplary embodiment;

FIG. 14 is another diagrammatic representation of a system and process in accordance with yet an additional exemplary embodiment;

FIG. 15 is another diagrammatic representation of a system and process in accordance with again another exemplary embodiment;

FIG. 16 is a flow diagram illustrating a process for delivering a targeted campaign message to the vehicle in accordance with again a further exemplary embodiment;

FIG. 17 is a flow diagram illustrating a process for delivering a targeted campaign message to a vehicle in accordance with again an added exemplary embodiment; and

FIG. 18 is a flow diagram illustrating a process in accordance with an exemplary embodiment.

### DETAILED DESCRIPTION OF THE INVENTION

Aspects of the invention are disclosed in the following description and related drawings are directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

While the specification concludes with claims defining the features of the invention that are regarded as novel, it is believed that the invention will be better understood from a consideration of the following description in conjunction with the drawing figures, in which like reference numerals are carried forward. The figures of the drawing are not drawn to scale.

The present invention provides a system and method for delivering information to a vehicle where the information is related, at least partially, to a particular criteria pertaining to the vehicle or driver. This criteria can include vehicle location, time of day, time of year, weather conditions, vehicle driver information, vehicle diagnostic information, vehicle-specific information (e.g., make, model, year, type, vehicle repair history and vehicle repair schedule), and many other pieces of information. Embodiments of the present invention provide a plurality of information types, such as sales and other commercial offers, and criteria used to determine which type will be transmitted and to whom, where, and at what time.

When one or more statistics associated with either the vehicle, the driver, or both, is known, the statistic(s) is compared to the criteria associated with each message and an advertisement message is transmitted to the vehicle for playback over the vehicle's audio system. In accordance with inventive aspects of the present invention, the driver could be given a choice of how the informational message is heard. This choice includes hearing a service description versus a service example. A service description is just that—details of the service are described to the driver in an effort to interest the driver and encourage the driver to purchase the service. A service example provides a dialogue, usually between two people, illustrating an example of how the service can be used. The voice application design of the present invention encourages the driver, or any other occupant within the vehicle, to listen to a service example, which can be randomly selected, instead of a service description. Research has shown that service examples are far more effective at selling than a less enjoyable service description. Embodiments of the present invention can feature multiple personas that add to the effectiveness of the up-selling technique.

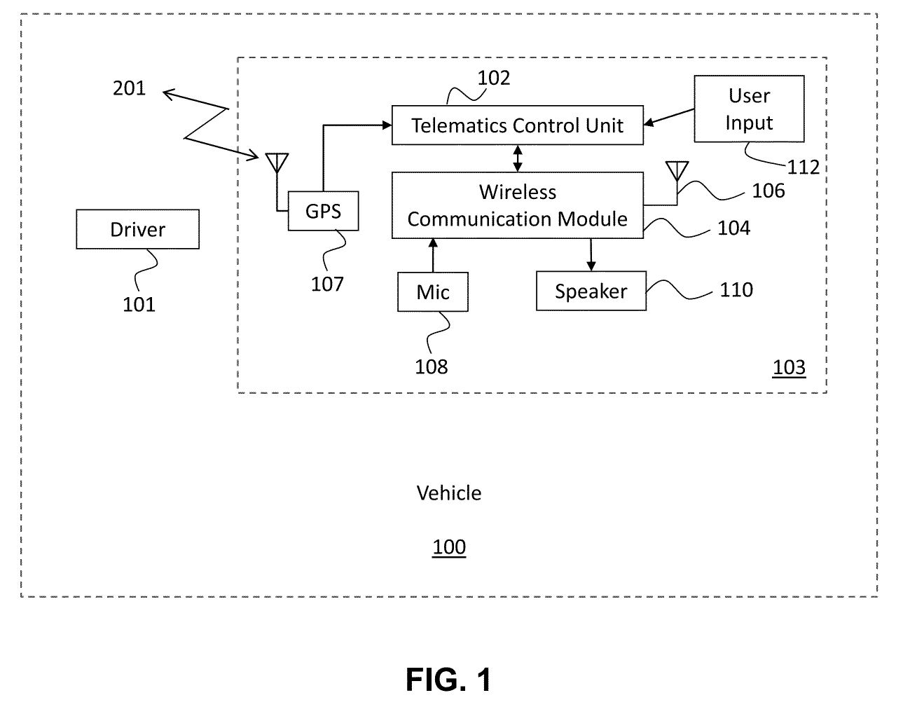

Referring now to FIG. 1, a block diagram of a representative system for delivering criteria-based messaging according to embodiments of the present invention is shown. A vehicle 100, which includes any structure capable of movement, is operated by a driver 101. The vehicle 100, according to one embodiment, is provided with a telematics system 103 that includes a telematics control unit 102, a wireless communication module 104, an antenna 106, a GPS receiver 107, a microphone 108, a speaker 110, and a user input 112, such as a button.

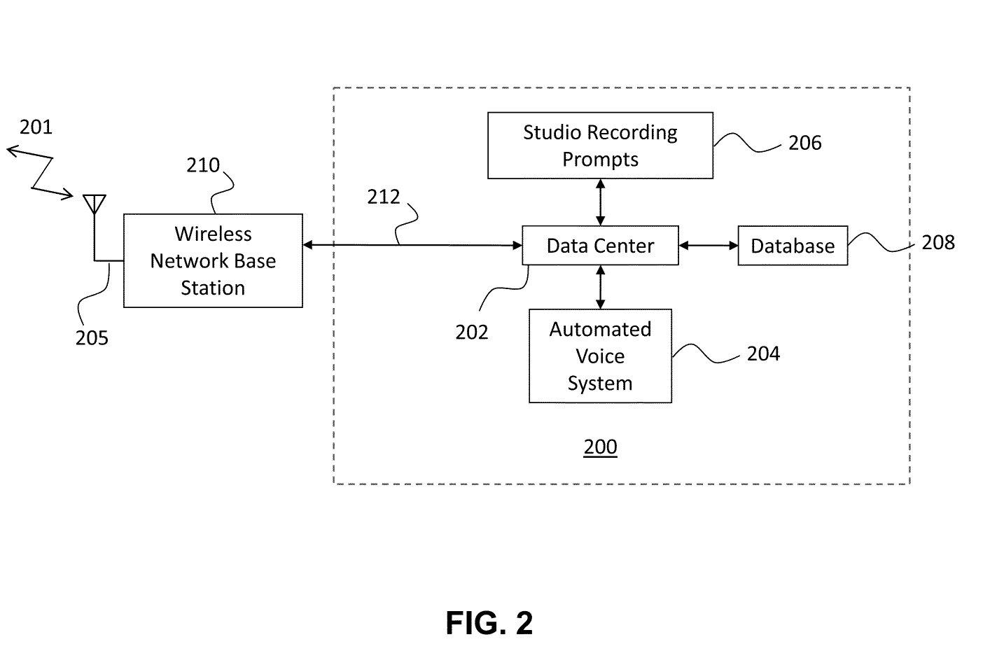

There are a number of exemplary uses for a telematics system 103. One exemplary use is the most commonly found use of a telematics system—to summon roadside assistance. For the present example, the entity supplying the telematics system 103 has live operators at a remote facility, e.g., at a control center 200, shown in FIG. 2, for providing roadside assistance through a voice communication. Further, the user input 112 is operable to call the control center 200 upon a single actuation. For example, the telematics system 103 can have a red “emergency” button that, when pressed, opens a communications channel to the operator. Accordingly, when the vehicle occupant presses the button, the appropriate software is called up to enable a “live-operator-communication.”

If, as shown in FIG. 1, the telematics system 103 has an embedded GPS system 106, the data sent to the control center 200 can include current GPS location coordinates. In this way, the operator can be provided with the information pinpointing the vehicle's location before voice communication occurs between the operator and the occupant.

Roadside assistance is only one of the possible telematics functions that could be provided with the inventive telematics system 103 of the present invention. Another function that is provided with the telematics system 103 is a door-unlock command. If the telematics system 103 is communicatively coupled with the device that unlocks a locked door of the vehicle, then the telematics system 103 can interface and actuate the door-unlocking device. If the telematics system 103 is connected similarly to the vehicle starting assembly, then the telematics system 103 can carry out a remote engine start with little added difficulty. Likewise, if the telematics system 103 has access to the vehicle's diagnostics bus, then any available diagnostic status can be made accessible not only to the driver, but also to an operator at the control center 200. In an emergency, where the driver/passenger(s) is not available, the telematics system 103 is programmed to automatically send a diagnostics state(s) to the control center 200.

It is noted that at least part of the telematics system 103 is integrated with the vehicle. Here, integrated or integral means that part of the system 103 is at least semi-permanently attached to the vehicle or parts of the vehicle. That is, integral or integrated does not describe devices, such as cellular phones, which can easily be carried into and out from a vehicle. In some embodiments of the present invention, the telematics system 103 is not supplied by the original equipment manufacturer, but is, instead, an aftermarket device. However, once the aftermarket device is permanently or semi-permanently connected to the vehicle's wiring (i.e., diagnostic data wiring), the aftermarket telematics device becomes “integral” with the vehicle. In each case, the integrated telematics system 103 is embodied in at least one physical component of the system 103 (i.e., a telematics “device”) present at the vehicle that is physically accessible and/or visible to an occupant within the vehicle. The telematics device houses at least one component of the above-describe telematics system 103 and is in communication with the other components of the system 103. For instance, at least the button 112 is physically accessible by an occupant of the vehicle and, generally, one or more lights will be visible within the vehicle's interior. Pushing the button 112 will cause one or more of the other system components to operate.

FIG. 2 is a block diagram of an exemplary remote control center 200. The remote control center 200 includes a data center 202, an automated voice system 204, studio recording prompts 206, and a database 208. The control center 200 receives communication signals from the vehicle 100 over a communication link 212 that is connected to a wireless network base station 210.

In the context of the present invention, a data center 202 is substantially a highly automated call center that is aimed at providing telematics services. The data center 202 communicates with vehicles through voice and data channels and is capable of managing a variety of vehicle-centric functionality, including vehicle emergencies. Live agents and automated voice systems 204 capable of conducting independent or integrated voice recognition (IVR) are components of the data center. In one exemplary embodiment, the type of data communicated to and from the vehicle includes, for instance, information related to vehicle location, diagnostic data, driver requests, and other vehicle-centric functionality. The voice-automated system 204 communicates with a vehicle driver much like a live agent would, although, when emergencies are involved, calls are routed to live agents whenever possible. Voice automated systems 204 play audio prompts to the vehicle driver that are recorded at a studio, usually by professional talent (high quality voices). In many cases, text-to-speech engines generate the audio prompts and yield a lower quality of speech as heard by the driver. Text-to-speech can be used in place of studio prompts to save on cost, but human recordings are preferred for most applications.

The off-board automated voice system 204 and the other components shown in FIG. 2 provide significant advantages. The intelligence behind the presently-inventive message criteria system is shared between the on-board and off-board components, but the major computing is performed at the control center 200, where more computing power is available than on the vehicle. Significantly, updates can be performed to the off-board components much easier than identifying and accessing the many mobile units utilizing the inventive system.

For an outgoing message from the control center 200 to the vehicle 100, the criteria-based audio messages are managed and transmitted by the automated voice system 204, then are passed through the data center 202, through one of many available telecommunications networks 212, through the wireless network base station 210 and the wireless network's antenna 205, over a wireless link 201 to the vehicle 100, through the vehicle mounted wireless antenna 106, through the vehicle mounted wireless communication module 104, and finally broadcast on the vehicle's speaker(s) 110 in a hands-free environment.

When a vehicle driver 101 initiates a telematics connection, the vehicle driver's spoken commands pass through the vehicle microphone 108, through the vehicle-mounted wireless communication module 104, through the vehicle mounted wireless antenna 106, over a wireless link 212, through the wireless network's antenna 214 and wireless network base station 210, through one of many available telecommunications networks 212, and into the data center 202, which is connected to the automated voice system 204.

Once the command arrives, the automated voice system 204 interprets the spoken command(s). Depending on the nature of the telematics request from the vehicle driver 101, the vehicle driver 101 can, for example, select a menu item, request to subscribe to a service, abort the session, command the system to perform any number of telematics tasks, or many other selectable options.

The telematics request can be accomplished automatically or by pressing the button 112 and speaking a command that is detected by the microphone 108 within the vehicle 100. When a telematics connection is established between the vehicle 100 and the control center 200, information is exchanged between the vehicle 100 and the control center 200. This information can include vehicle location, vehicle model information, vehicle driver information, diagnostic information, and other information, all referred to generally as “statistics” herein. Some information may be known before the driver 101 pushes the button 112 and some statistics are captured at the time or after the button 112 is pushed. It is noted that pushing a button is only one exemplary way to cause the system to initiate a functional state and other methods, such as speaking a particular word, are contemplated by the exemplary embodiments of the present invention.

After communication between the vehicle 100 and control center 200 is established, the vehicle driver 101 hears audio prompts through the speaker 110. The speaker 110 can be the vehicle's factory equipped speakers or can be aftermarket add-on speakers, preferably located in proximity to the vehicle driver 101. Depending on conditions at the time of the telematics service request (i.e., the button push), the vehicle driver 101 may or may not hear an audio message.

Criteria-Based Messaging

As just one example of the inventive systems and processes, a vehicle driver is exposed to an audio message when it is determined that the vehicle's location is within a specified radius surrounding the location of an upcoming event that is scheduled to occur. The intent of the message could be to promote the event to the driver with a short audio message that is played inside the vehicle using audio equipment located therein, such as speaker 110. More specifically, if the event were, for instance, a sale at a car dealership, the car dealer would register the event with the control center 200 in advance and provide information relevant to the sale. The dealer could also select criteria prerequisites that the control center 200 would then use to filter potential message recipients based on their statistics within particular criteria categories. For instance, if the dealership was a MERCEDES® dealership, one criteria could be whether or not a person is a current owner of a MERCEDES® vehicle. A statistic would be the year or model of the MERCEDES®. Therefore, as an example, a dealership could specify that the sale would be announced: 1) only to drivers of MERCEDES® vehicles; 2) only to drivers of MERCEDES® vehicles manufactured more than five years prior; and/or 3) only to drivers of MERCEDES® vehicles manufactured more than five years prior that are currently within five miles of the dealership.

In some cases, the audio message will reference the event and provide directions and other information that will allow the user to attend the event either immediately or at a later date. In addition, the message may indicate that an email with details will be sent to the driver. This communication lets the driver know to expect the message, hopefully making the driver more willing to read it once he or she sees it in his or her inbox. In the email scenario, the driver is assumed to be a current service subscriber and the remote message center would have access to customer data, such as an email address.

Examples of telematics services are virtually unlimited, but include, from a remote center 200 to a driver 101, provision of directions, location of nearby stores, restaurants, parks, highways, etc., placing reservations for the driver, directing emergency services to the vehicle's location, and the provision of many more services. In addition, the telematics system 103 is connected to multiple sensors throughout the car. Advantageously, the telematics system 103 is able detect a large number of attributes of the vehicle at any time. The attributes include the condition of the vehicle, such as the vehicle's diagnostic information (e.g., engine statistics), orientation of the vehicle (e.g. the car is angled or upside down), whether airbags have deployed, whether the oil needs to be changed, if the car is mobile without a seatbelt connected, and many more. Each of these attributes can be transmitted to the remote data center 202 and can be the subject of a criteria-based message.

Vehicle Relationship Management

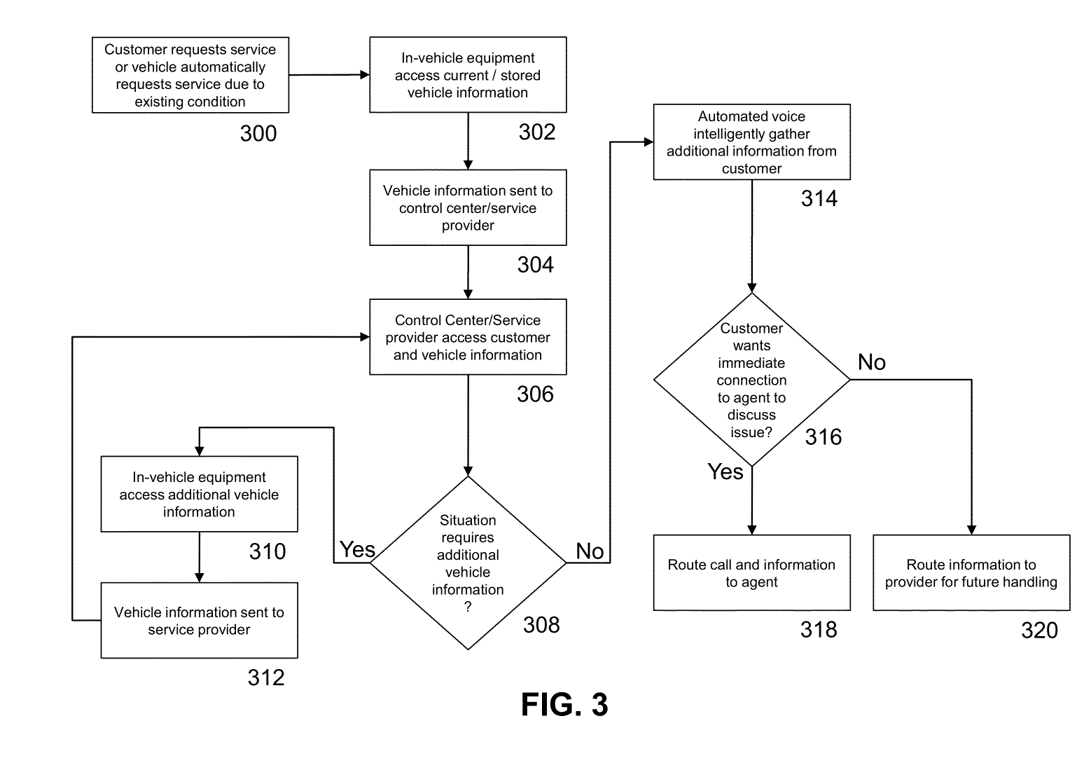

In accordance with an exemplary embodiment, the telematics system 103 provides a service link connecting the vehicle 100 with a service provider (also referred to as a dealership or a service department) in situations where it detects a vehicle malfunction from the vehicle's diagnostic information, an unusual orientation of the vehicle, or any other attribute(s) of the vehicle that requires service provider assistance. Alternatively, the vehicle driver 101 may initiate a telematics request for service assistance if he or she detects a potential vehicle malfunction. In the context of this exemplary embodiment, the telematics system 103 functions as a vehicle relationship management (vRM) system. The intent of the vRM system is to optimize customer satisfaction through sophisticated delivery of collated information about the vehicle 100 to the service provider and is described with regard to the flow diagram of FIG. 3.

In this example, in step 300, a vehicle driver 101 initiate a telematics connection and requests service by speaking a command related to a vehicle service inquiry (e.g., “There is a grinding noise when I step on the brake.”). Alternatively, the vehicle 100 automatically requests service due to an existing condition (e.g., a service light illuminates). In step 302, the equipment in the vehicle stores the information to be sent and/or accesses current status information so that, when the telematics connection is established between the vehicle 100 and the control center 200, in step 304, the vehicle location, diagnostic information, and other statistics are exchanged between the vehicle 100 and the control center 200. In another exemplary embodiment, the control center 200 has the ability to directly transmit the data to the actual service provider, whether it is preset as a designated service provider in a user profile or it is dynamically obtained by finding the closest service center to the current position of the vehicle. The control center or service provider accesses and evaluates the customer and vehicle information in step 306. The control center 200 or the service provider can interrogate the vehicle 100, in step 308, for sensor data and codes if additional information is required. This interrogation can be carried out by the control center 200 or the service provider. Communication is established with the vehicle in step 310 and, in step 312, the additional information is sent to the requesting party. Anytime after the automated voice system 204 interprets the user's request, the control center 200 can provide an audio message back to the vehicle 100, for example, with a confirmation of receipt and instructions what to do, or with directions to the nearest service provider, e.g., the closest dealership.

When no further information is required for the service call, the control center 200 or the service provider gathers all information to complete a service call in step 314. The system can provide the vehicle with a query, in step 316, to see if the user wants immediate connection to a service agent. If immediate connection is requested, in step 318, the call is routed to the selected service agent. If immediate connection is not requested, in step 320, the information is routed to the appropriate service agent for use when the vehicle arrives.

The control center 200 delivers the driver's command and/or vehicle statistics to the service provider by any suitable delivery system known or contemplated by one of ordinary skill in the art. For example, a control center agent who has communicated with the driver 100 can call the service provider manually and report the vehicle service issue, or the control center 200 can deliver a recorded audio file of the driver's command (e.g., an interactive voice recognition dialogue between the control center agent and the driver 101, possibly as a .WAV audio file) to the service provider. Accordingly, when the driver 101 arrives at the dealership, the service department, having already received the vehicle statistics, can quickly diagnose and service the problem. In addition to using the vehicle telematics system 103 to contact the control center 200, it is also within the scope of the present invention for the driver 101 to contact the control center 200 through a mobile or land phone.

As another example, a vehicle driver 101 can initiate a telematics connection and speak a command related to a vehicle service inquiry (e.g., “There is a grinding noise when I step on the brake.”). When the telematics connection is established between the vehicle 100 and the control center 200, vehicle location, vehicle diagnostic information, and other statistics are exchanged between the vehicle 100 and the control center. The control center 200 interrogates the vehicle 100 for all sensor data and codes. After the automated voice system 204 interprets the request, the control center 200 can provide an audio message back to the vehicle 100 with directions to the nearest service provider, e.g., the nearest dealership. Additionally, the control center 200 delivers the driver's command and/or vehicle statistics to the service provider by any suitable delivery system known or contemplated by one of ordinary skill in the art. For example, a control center agent who has communicated with the driver 100 can call the service provider manually and report the vehicle service issue, or the control center 200 can deliver a recorded audio file of the driver's command (e.g., an interactive voice recognition dialogue between the control center agent and the driver 101) to the service provider. Accordingly, when the driver 101 arrives at the dealership, the service department, having already received the vehicle statistics, can quickly diagnose and service the problem. In addition to using the vehicle telematics system 103 to contact the control center 200, it is also within the scope of the present invention for the driver 101 to contact the control center 200 through a mobile or land phone.

In another example, the control center 200 could also provide a service link between the vehicle and a service provider to report to the service provider a customer's demographic profile, e.g., how many miles a vehicle 100 has driven. In accordance with the present invention, the service link can be used to synchronize any type of human-machine interface (HMI) data about a vehicle 100 to a service provider through, for example, a live phone call, an audio message, an IBF file, a text or email message, or any other type of message known or contemplated by one of ordinary skill in the art.

As a further example of vRM, the control center 200 schedules a service appointment with the service provider. A control center agent can contact (e.g., call, message, email) the service provider for scheduling or the control center 200 can deliver a message to the service provider that they need to follow-up with the driver 101 for scheduling. In another example, the control center 200 is operable to connect to and interface with the service provider's scheduling system and automatically schedules a service appointment for the vehicle 100. If the control center 200 is able to schedule a service appointment, it sends a message to the driver 101 regarding the service appointment (e.g., through the in-vehicle telematics system 103, an email, text, or a phone call). In yet a further example, the control center 200 not only transfers calls and/or messages and/or data to the service provider, it follows up with the service provider to ensure that the service provider attends to the calls and/or messages and/or data. The control center 200 also reports back to the driver for follow-up as well.

In embodiments of the present invention where a telematics request is initiated by the button 112, a criteria-based message could be delivered after the driver pushes the button 112, but before the telematics request is delivered to the driver. In other words, the actual telematics request could be fulfilled after a short audio message is delivered to the driver. For example, if the vehicle driver 101 pushed the telematics button 112 for the purpose of getting driving directions from a call center agent, the criteria-based audio message would occur first. Embodiments of the present invention also provide for an interrupt feature where the driver 101 can halt the output of the message and jump to whatever driver assist query he or she was seeking.

Another example of criteria-based messaging involves service promotion, or up-selling. For example, a vehicle driver 101 may initiate a telematics request by pushing the button 112 inside the vehicle 100. Although the button 112 is referred to herein in the singular, the button 112 can be multiple buttons. Examples of such buttons 112 include an SOS button, an information button, a concierge button, or a roadside button. Depending on conditions at the time of the telematics service request, the vehicle driver may or may not hear a criteria-based audio message. For illustration purposes, assume that the vehicle driver 101 pushes a concierge button, but the driver is not a subscriber to the concierge service. A dialogue would be initiated by the voice automation system 204 and prompting would occur with the intent of up-selling the vehicle's driver 101 by transforming the mood of the driver 101 into a buying mode.

As another example, a criteria-based message may be initiated by an upcoming or past expiration of a user's subscription to a service. In addition, a newly available subscription could be the subject the initiates a message being broadcast to a driver.

Order Management

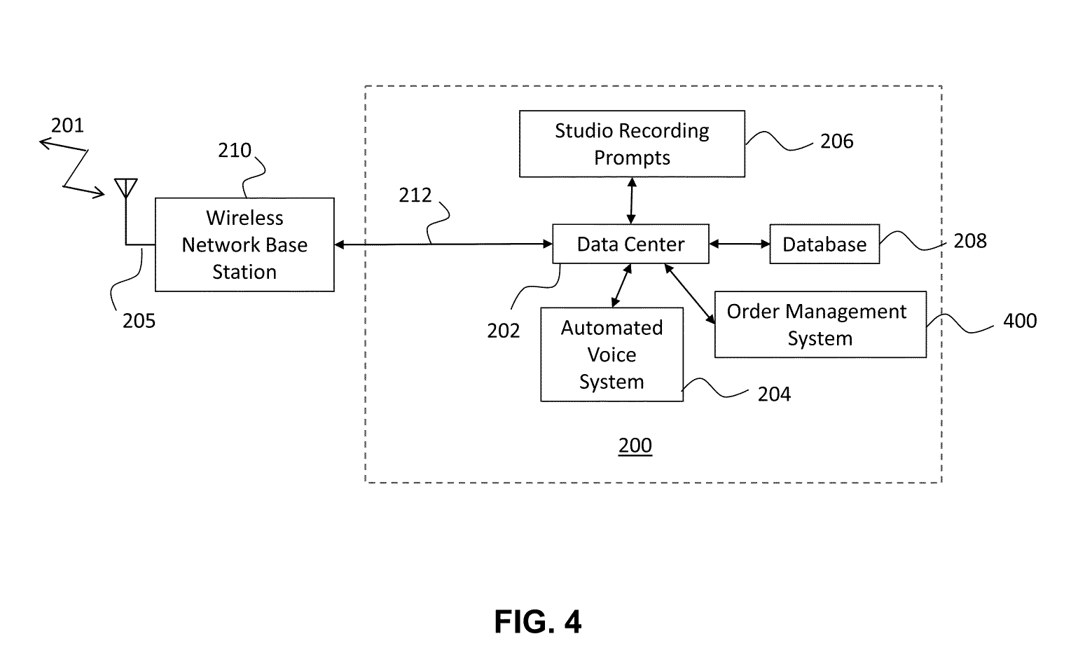

Referring to FIG. 4, the exemplary control center 200 further includes an order management system 400 for processing service orders, e.g., new service subscriptions or up-selling, which may be in response to the service promotions described above. Many vehicle drivers or customers are enrolled initially into a package-based subscription for vehicle services. Certain events may happen along the way that complicate how a subscription or particular services associated therewith are canceled, which can be confusing to the customer or subscriber. The cancellation of one out of many services of a subscription or an upgrade to add additional services mid-stream to the subscription can provide difficulties in tracking a customer's subscription or the financial accounting of subscribed services when the different services are started at different times. Additionally, it is difficult to track multiple orders for each transaction incurred with a service provider. Traditional order management systems compute, store, and present individual orders for each of the business transactions when purchase or purchase modifications such as a cancellation or a date/content adjustment of products and services needs to take place. The approach requires a special effort when computing orders, presenting orders to a customer, and tracking inventory and maintenance, as well as special marketing efforts for individual services when the services are non-coterminously purchased and do not have aligned expiration dates.

An exemplary order management system 400 is operable to maintain coterminous subscriptions in one active order. The order management system 400 is a computer-implemented system for processing, storing, and presenting business transactions of an individual customer. Only one active order per customer is present in the system at any given time, which reflects initially purchased or granted free of charge services and additional services ordered by the customer in one or multiple sequential business transactions following the initial purchase. Current and future customer purchased services inventory are also reflected on a single order. The order management system 400 is operable to align end dates of services listed on a single active order, which is inclusive of all services purchased by a customer during more than one business transaction, with or without pro-ration of the price, and which allows customer purchased services to be marketed to the customer on the same calendar date prior, at, or after services expiration date.

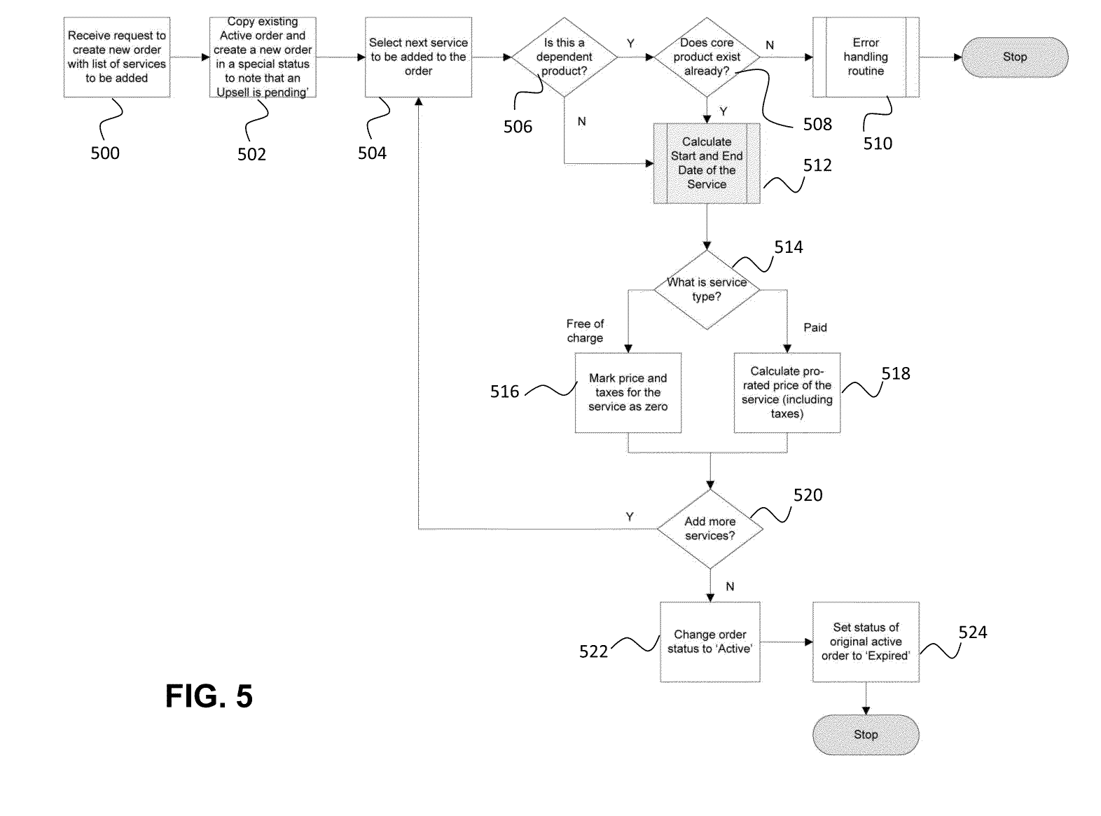

The present invention provides a straightforward and seamless orders summary presentation to customers and call center agents and allows for a simplified marketing approach for service renewals. FIG. 5 illustrates exemplary steps for creating an order for sequential business transaction with end date alignment and price proration. At step 500, the exemplary system receives a request for new orders with a list of services to be added. At step 502, the preexisting active order is copied and a new order is created with a special status note that an upsell is pending. The next service to be added to the order is then selected at step 504. At step 506, an inquiry is made as to whether or not the new order is for a product dependent on the preexisting order. If yes, the process proceeds to step 508 where an inquiry is made as to whether or not the core product already exists, and, if not, it is determined that there was an error, at step 510, and the process stops. If, at step 506, it is determined that the new product is not a dependent product, or, at step 508, it is determined that a core product does already exist, the start and end date of the service is calculated at step 512. At step 514, an inquiry is made as to the type of service. If it is determined that the service is free-of-charge, then the price and taxes for the services are marked as zero at step 516. If, however, the service is not a free-of-charge service, then the prorated price of the service is calculated, including taxes, at step 518. At step 520, there is an inquiry as to whether additional services are to be added, and, if yes, the process returns to step 504. If there are no additional services to be added, the order status is updated to “active” at step 522 and the status of the preexisting order to changed to “expired” at step 524.

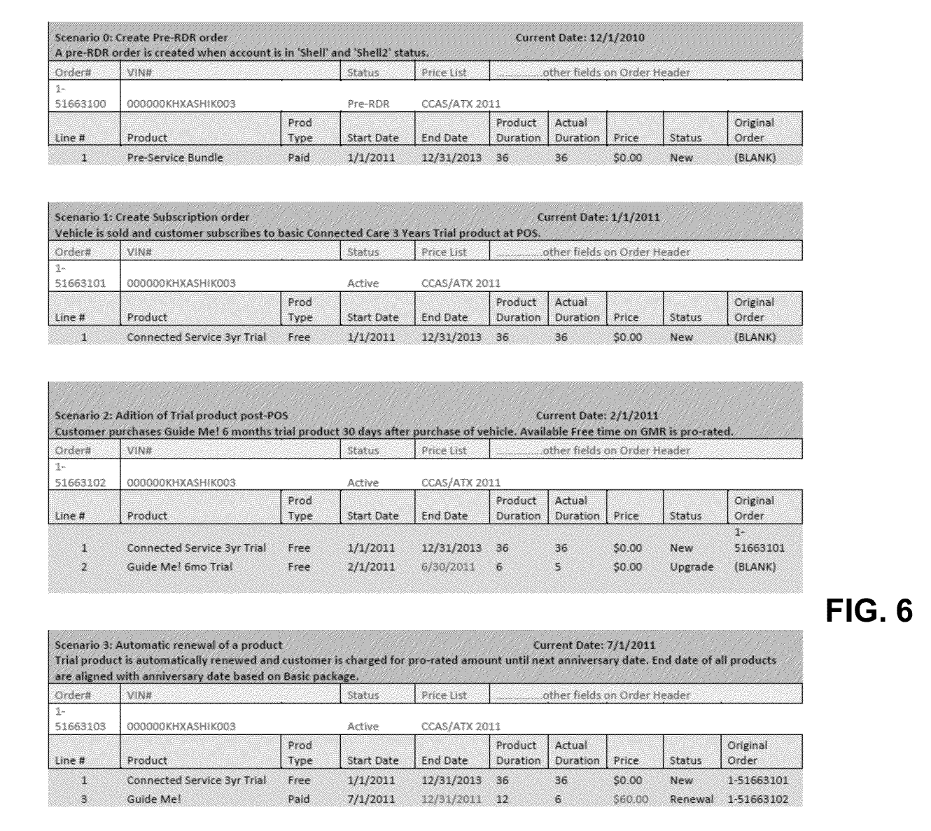

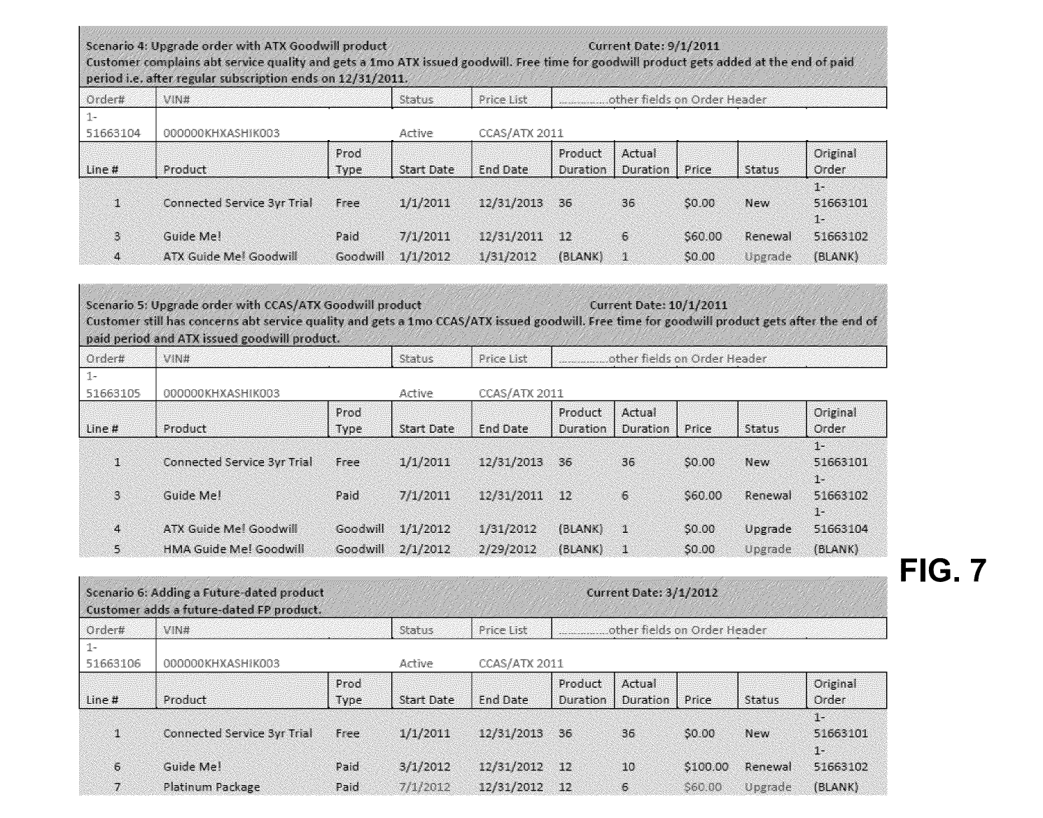

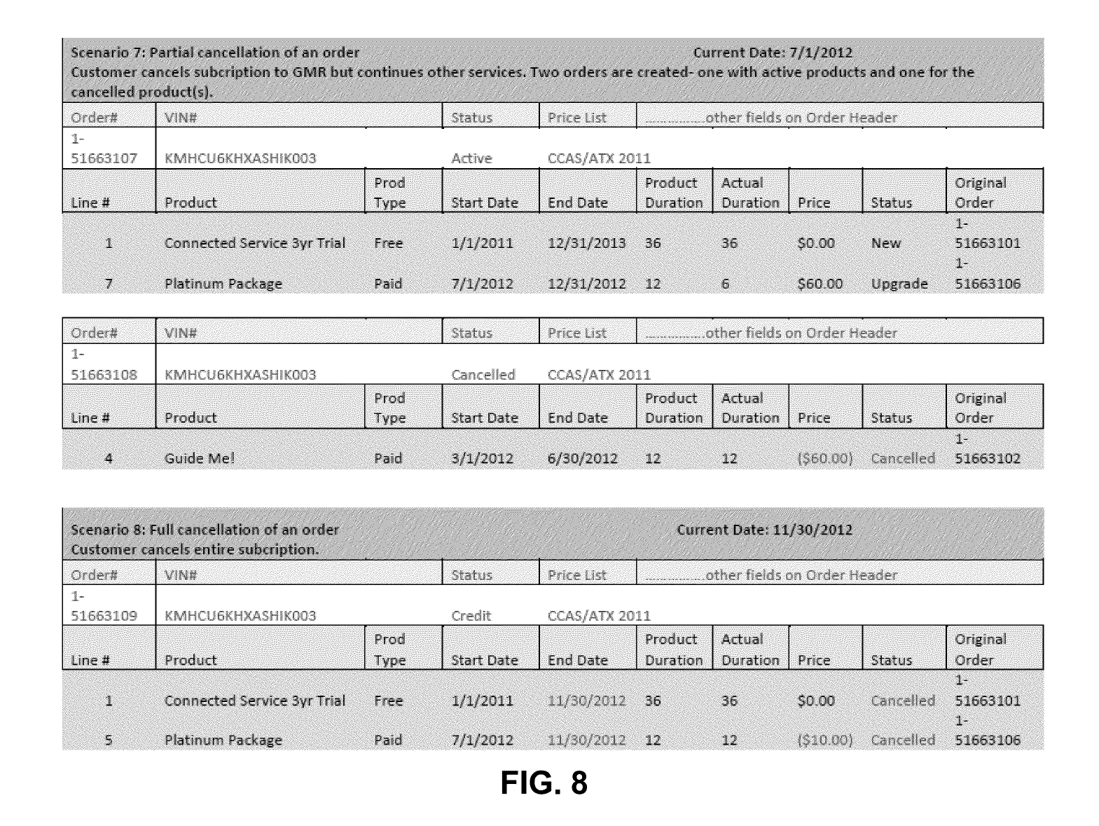

Accordingly, FIG. 5 shows how customer account activity is governed by one coterminous active order, which the order management system 400 recognizes and tracks along the life of the subscriber. Thus, the order management system 400 condenses customer transactions into a baseline so that the customer understands for what he or she is being billed. FIGS. 6 to 8 illustrate various exemplary order forms for use with the order management system 400 of the invention. Scenario 0 in FIG. 6 illustrates the order form before an account has been activated or sold. Scenario 1 in FIG. 6 illustrates the creation of a subscription to activate the account, for example, with a three-year trial membership. Scenario 2 in FIG. 6 illustrates how the order is processed when a customer purchases a six-month trial membership thirty-days after purchase of a vehicle and after the three-year trial membership was activated. Scenario 3 in FIG. 6 illustrates how the order is processed when the six-month trial membership in Scenario 2 is renewed. In this scenario, the customer is charged a pro-rated amount until the customer's next anniversary date. The end date of all products are aligned with the anniversary date of the basic subscription added in Scenario 1. Scenario 4 in FIG. 7 illustrates how the order is processed when a good-will upgrade is added to the user's account. Scenario 5 in FIG. 7 illustrates how the order is processed when a second good-will upgrade is added to the user's account. Scenario 6 in FIG. 7 illustrates how the order is processed when an upgrade product is purchased to start on a future date. Scenario 7 in FIG. 8 illustrates how the order is processed in a partial cancellation. Here, the customer cancels the subscription of one product and that product is removed from the user's account. Finally, Scenario 8 in FIG. 8 illustrates how the order is processed when a complete cancellation of services occurs on a user's account.

A system and process for managing orders with a rolling orders summary having only one active order per customer at a time is advantageous to the customer. This process is triggered by subsequent orders, e.g., an up-sell, that would terminate an existing order and process the new order as active while maintaining the integrity of the order history. This process eliminates the need for asset tracking for devices. Moreover, all management is performed on the orders, which significantly lowers implementation and maintenance costs.

Criteria-based messaging can also be used to inform a driver that a new location-based service is available. A traffic report is just one example of a service that is only available and relevant in certain locations, such as metropolitan areas. Traffic reports are not available or considered as important in many regions where traffic is sparse. A vehicle driver may be in an area that has grown in population to the extent that traffic can be an issue. As new traffic services become available, criteria-based audio messaging can be used to inform drivers that traffic information is available in their immediate area, identified by the GPS component 107, or an area that the GPS component 107 has identified that vehicle as traveling through at least once. Depending on a vehicle's location at the time of a telematics service request, the vehicle driver may hear a criteria-based audio message indicating that traffic service is now available.

Likewise, there may be a new facility or tourist attraction that could be advertised to a vehicle driver based on vehicle location. Again, a telematics request could be fulfilled after a short audio message is delivered to the driver.

Campaign Handling

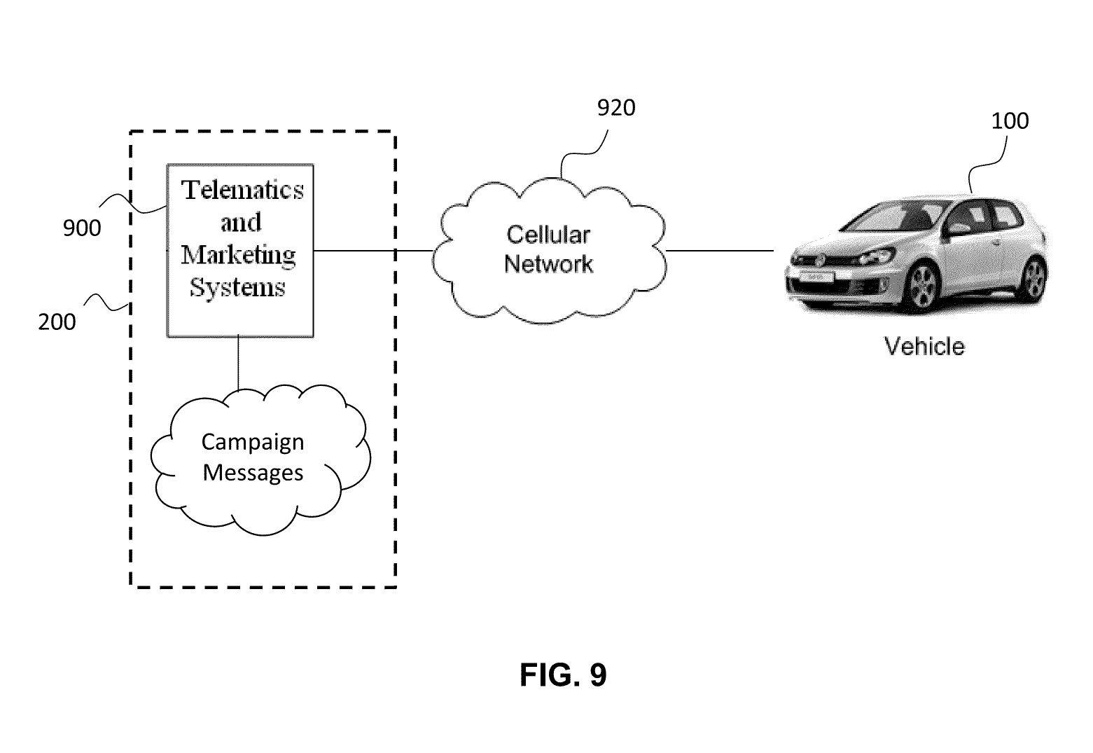

Referring to FIGS. 9 to 17, other examples of criteria-based messaging involve messages used for campaign or marketing purposes. As a first example, the criteria-based messaging includes a welcome or drive-off campaign after the purchase of a new vehicle. The intent of the welcome campaign is to provide an introduction to vehicle features and services available to the vehicle 100. A vehicle driver 101 may trigger the welcome campaign by the first button push or other event such as a voice command within the vehicle 100. The event triggers communication between the in-vehicle telematics system 103 and an off-board marketing and information services platform 900, which is located at the control center 200 and houses the algorithms to notify the readiness of the vehicle 100 to accept marketing campaigns and deliver them through the voice and/or data channels. Additionally, the marketing and information services platform 900 is operable to interrogate the status of the vehicle 100 and other pertinent account profile information to tailor a specific message to the appropriate channel for in-vehicle delivery.

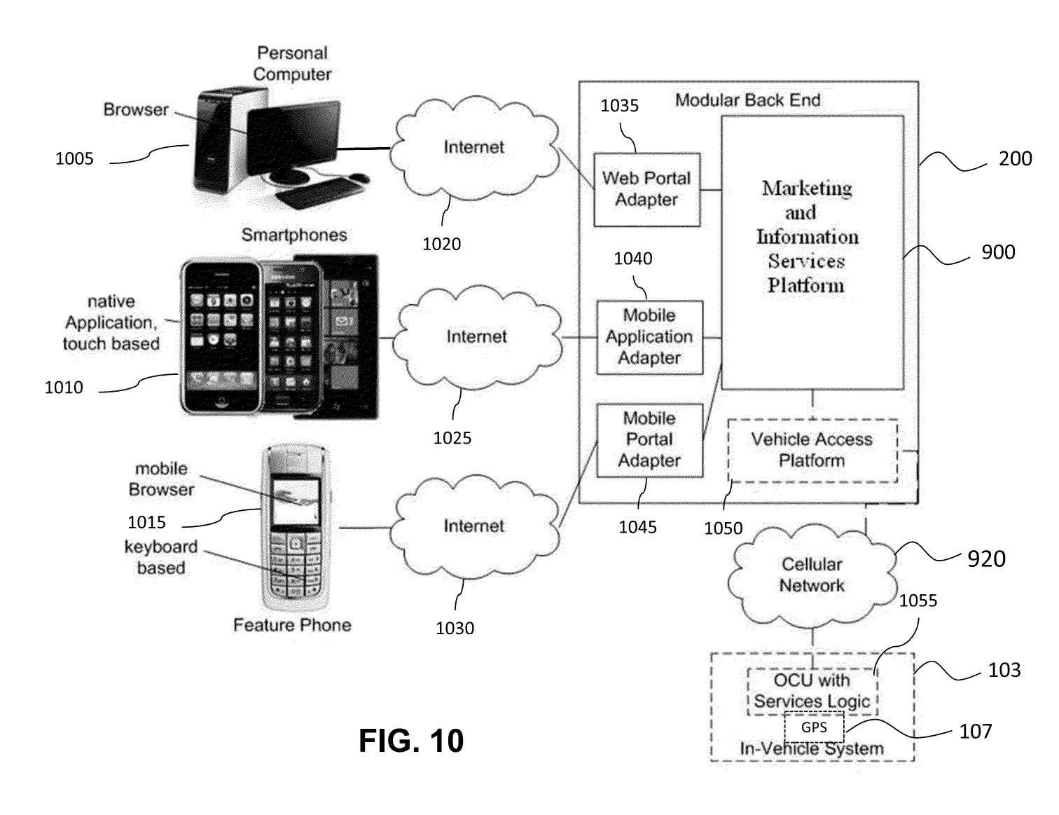

As shown in FIGS. 9 and 10, the communication connection between the vehicle telematics system 103 and the marketing and information services platform 900 can be through a cellular network 920 similar to the communication connection described in U.S. patent application Ser. No. 12/363,267 and its related applications, all of which have been incorporated herein. Alternatively, the communication connection between the vehicle telematics system 103 and the marketing and information services platform 900 can be similar to the communication connection shown and described with respect to FIGS. 1 and 2.

As shown in FIG. 10, vehicle telematics system 103 may include an office channel unit (OCU) 1055 with services logic to connect with a vehicle access platform 1050 of modular back end 200 via cellular network 920. Vehicle telematics system 103 may also include a GPS. Modular back end 200 includes marketing and information services platform 900. Vehicle telematics system 103 may communicate with platform 900 via network 920 and vehicle access platform 1050. A user may communicate with marketing and information services platform 900 other devices besides vehicle telematics system 103. These other devices may include personal computer 1005, smartphone 1010, and feature phone 1015. Devices 1005, 1010, 1015 may communicate via the internet 1020, 1025, 1030 with platform 900 using adapters 1035, 1040, 1045. In addition to receiving marketing messages via network 920 at vehicle telematics system 103, marketing messages may be received at devices 1005, 1010, 1015 via the internet.

Additional examples of criteria-based messaging include location-based campaign messages, where the exemplary marketing and information services platform 900 is operable to provide marketing materials to the vehicle telematics system 103 based on the location of the vehicle 100. In these exemplary embodiments, the control center 200 is operable to read routes calculated by an in-vehicle navigation system, and, based on the current GPS coordinates (identified by the GPS component 107), predefined customer POI preferences along the route, and/or the time of day, the control center 200 delivers a personalized message to the driver 101 through a preselected mode of communication. Examples of modes of communication include text messages, in-vehicle audio messages, images on an in-vehicle display, email messages, or a web site account. Predefined customer POI preferences may be configured using an off-board web portal 300 in communication with the control center 200, similar to embodiments described in co-pending U.S. Provisional Application Ser. No. 61/497,768 [Atty Docket: Agero/Custom Content].

Thus, location-based messages can be associated with preset categories that align with driver interests and needs. Examples of user preferences that can be predefined in a profile stored at the data center 202 include preferred restaurants, bars/pubs, clothing stores, health facilities, and ATMs/banking service locations that are relevant to the user. Through the web portal 300, the vehicle operator 101 can predefine favorite POIs along familiar driving routes and/or synchronize POIs set in the vehicle 100 to those on the web portal account where the vehicle operator 101 could opt-in to receive proximity-based messages from designated POIs. Accordingly, marketing messages targeted to a driver's predefined preferences are delivered to the driver based on the driver's current location. For instance, a driver 101 predefines in his or her profile that he or she likes/prefers/loves restaurant A. The control center 200, operable to receive location information from the GPS 107, delivers an audio message to the vehicle 100 regarding a 2-for-1 deal at restaurant A located five miles from the driver's current location.

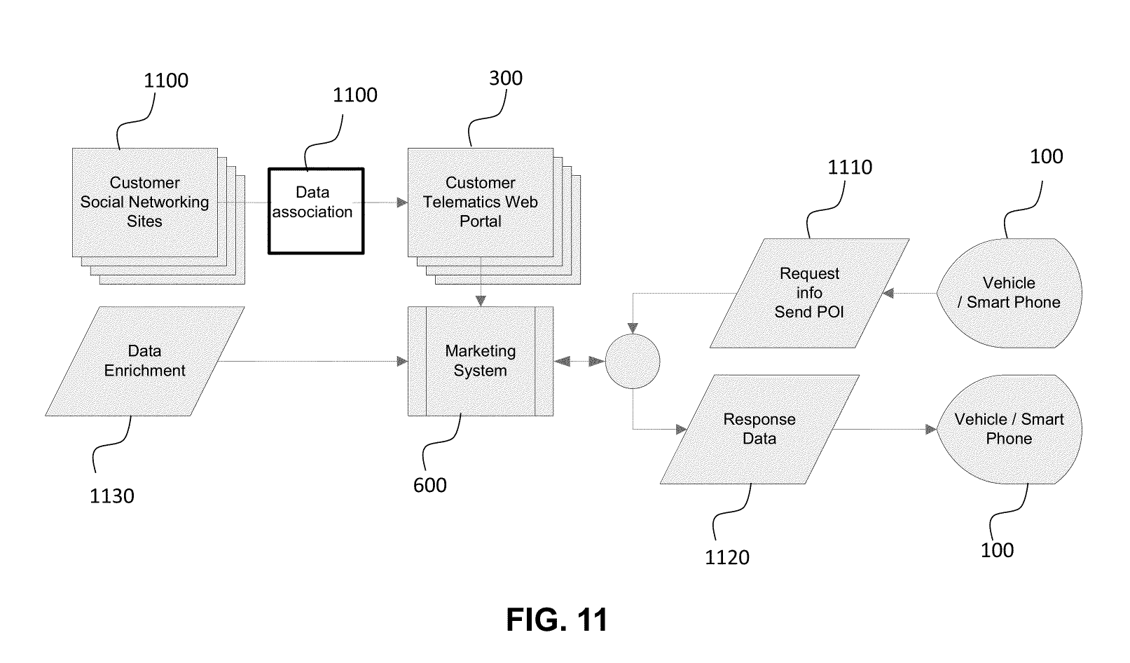

In another example, referring to FIG. 11, while driving, the vehicle operator 101 requests info, e.g., “closest shoe stores,” (at block 1110) and the system returns (at block 1120) the POIs sorted, first, by nearest location (identified by the GPS component 107) and, second, by customer preference. The vehicle operator 101 selects the appropriate location and can choose to hear a targeted message or a brand re-enforcement message from that selected POI while in route. For the customer's favorite POIs, where recent purchase data is known and linked to their personal profile on the web portal 300, this information is used (at block 1130) to further refine the targeted message with a reminder of the most recent purchase or, for example, a prompt like the following: “customers who purchased (product most recently purchased) also viewed/purchased these products as well.”

In another exemplary embodiment, the criteria-based messaging system is operable to aggregate content from various POIs and, based on customer profiles, assign a relevancy, e.g. priority, to the content. In other words, the system can filter targeted messages from various POIs, by assigning a relevancy to the targeted messages based on predefined user preferences, and send only those messages with a higher relevancy, i.e., greater preference, to the vehicle 100 associated with a particular user profile.

In accordance with another exemplary embodiment, the driver 101 can set permissions regarding the receipt of the above-described targeted marketing messages. In other words, he or she can opt-in or opt-out to receiving such messages.

Moreover, referring back to FIG. 11, the vehicle operator 101 could integrate his/her web portal 300 account with his/her favorite social networking applications 1100 (at block 1140) to leverage areas of interest such as FACEBOOK® Places (POI type) or FOURSQUARE® shared through mutual friends and purchase propensity affiliations from GROUPON® or other such social services that identify the intersection of location and product purchase interests along a given route where proximity and timing are key relevance criteria. The ability for the marketing system 900 to pull social network data, and, if needed, user account data, from social networking sites 1100 makes it relevant and location-aware while driving, which is very desirable to a vehicle operator 101.

Additionally, the control center 200 can dynamically calculate personalized campaign messages, which can be modified on the fly through direct in-vehicle customer feedback, and update the marketing and information services platform 900 to redefine future personalized campaign messages. The key data points upon which the marketing campaign algorithm can be based are, for example, cost of the vehicle owned, neighborhood of principle garaging, and market value of primary residence. Any other data that the system may be able to obtain from outside sources can also be included as a data point for the marketing campaign algorithm.

In another example, the criteria-based messaging system uses the history of driver requested POI searches to determine the most frequently visited POI locations, which information is used to present targeted marketing campaign messages. For this purpose, the criteria-based messaging system may incorporate a tracking system like that disclosed in co-pending U.S. Provisional Application Ser. No. 61/497,768 [Atty Docket: Agero/Custom Content]. For those POI locations that provide information regarding services offered, targeted messages can be dynamically supplied directly to the driver 101. For example, a history of driver requested POI searches reveals that the driver frequently visits restaurant A. Accordingly, the marketing and information services platform 900 delivers messages regarding promotions at restaurant A to the vehicle 100 because it knows, based on the tracked POI history, that the driver 101 has a particular preference for restaurant A. Upon receiving a campaign message from restaurant A, the driver 101 may opt to hear additional information such as lunch or dinner menu options based on the time of day and proximity to the location while in route within the vehicle. The driver 101 may further be able to make a reservation at restaurant A through the communications with the control center 200.

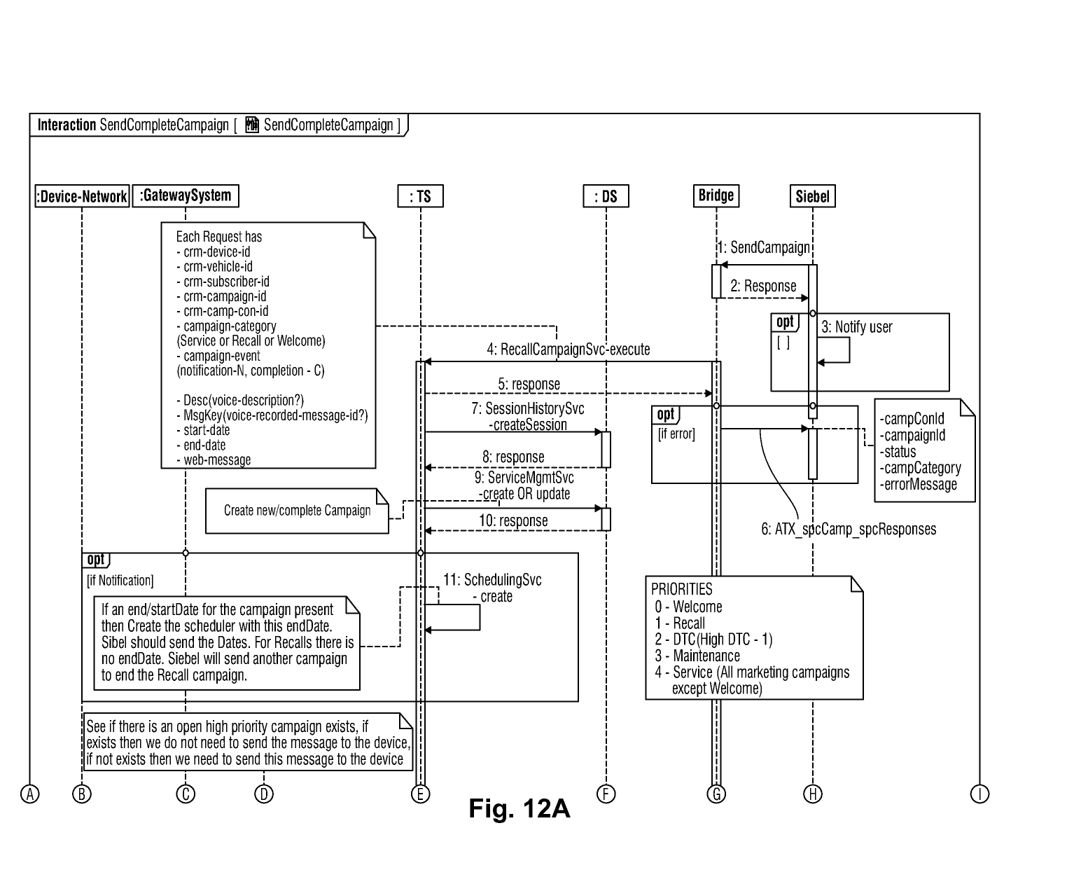

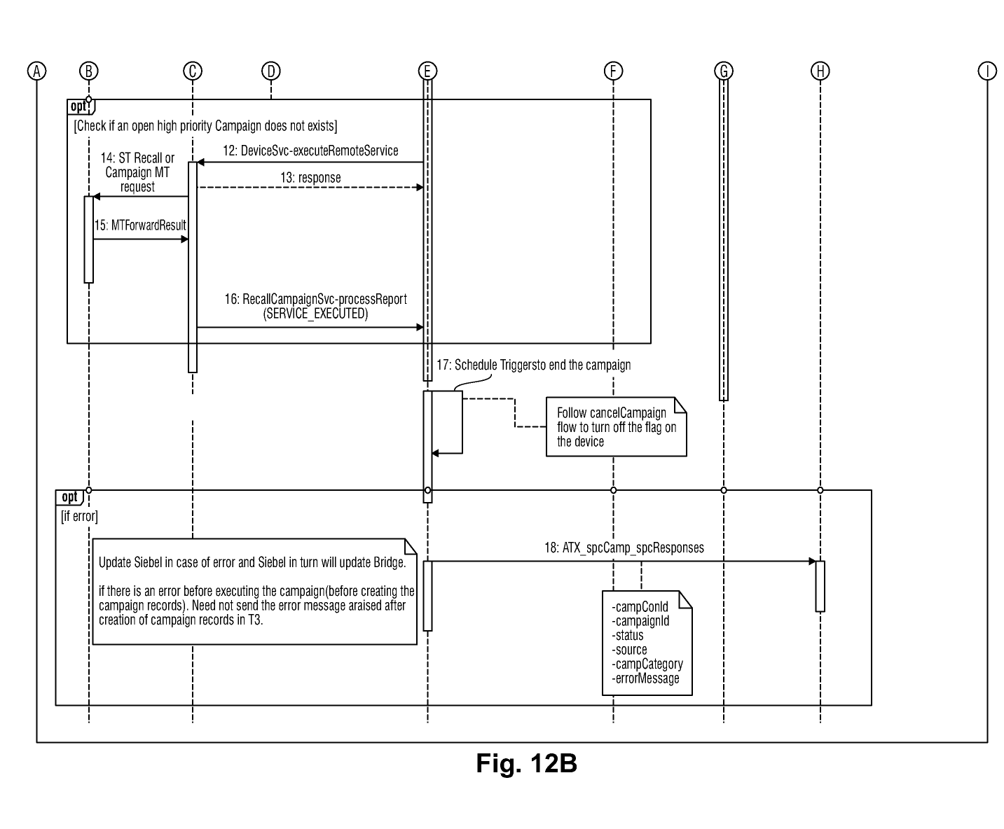

In accordance with exemplary embodiments, FIGS. 12 to 15 each outline steps for delivering a targeted campaign message to a vehicle. These figures detail the recall/marketing campaigns and describe flows for sending/creating/completing the campaigns, request messages on IVR, Web and cancelling the campaign. Various exemplary campaigns are listed and some are described. The exemplary campaigns include “Welcome,” “Recall Service,” “Auto-DTC (Auto-Diagnostic Trouble Code),” “Maintenance,” and “Campaign Service.” When there are multiple Recall Service messages, they are ordered based on Message Delivery Date, oldest first. When there are multiple Auto-DTC messages, they are ordered based on the date and time of the DTC Date sent by the vehicle, oldest first. When there are multiple open Maintenance alerts, they are ordered based on interval priority, highest priority first. When there are multiple marketing Campaign Service messages, they are ordered based on Message Delivery Date, oldest first. In this example, priorities of the campaigns with respect to one another are as follows: Recall Service has first priority, AUTO-DTC has second priority, Maintenance has third priority, and Campaign Service has fourth priority.

In FIGS. 12 to 15, various systems and processes are graphically represented at the top of the flow diagrams. In this example, the systems and processes interrogate the initial message type according to priorities described above. The “Device Network” is the customer vehicle 100. The “Gateway System” or “GS” is the entry point into remote data center 202. “TS” is part of the telematics platform (“T3”) at the data center 202. “DS” is also part of the telematics platform at the data center. The “Data Bridge” or “Bridge” is the systems and processes between the telematics platform and the Customer Relationship Management (CRM) system. “Siebel” is the CRM system, which stores data such as first name, last name, and other typical customer data.

The flow diagram in FIG. 12 illustrates how the systems and processes work to deliver campaign messages. First, the campaign is formed in step 1 and sent to the bridge, which confirms receipt of the campaign in step 2. The bridge then sends the campaign to the telematics platform T3 in step 4, utilizing both DS and CS. Each request, e.g. the campaign execution request of step 4, may include a device identifier, a vehicle identifier, a subscriber identifier, a campaign identifier, a campaign contact identifier, a campaign category, a campaign event field, a description field, a message identifier, a start date, and end date, and a web message. The device identifier is present in every request, however, other information that may be included in each request is optional. The campaign category may be related to a service, a recall, or a welcome. In one embodiment, the campaign event field may contain “N” for notification or “C” for completion. In one embodiment, the description field may contain a voice description. In one embodiment, the message identifier may be a message key or a voice recorded message identifier. In step 3 the user is optionally notified of a targeted pending message through the vehicle campaign system. Acknowledgement of campaign receipt is received from telematics platform T3 at the bridge in step 5. The bridge optionally acknowledges to the CRM system of an error in step 6. This optional notification may include the campaign contact identifier, the campaign identifier a status, a source, a campaign category, and the error message. At step 7, TS initiates the creation of a session by sending a message to DS. DS sends an acknowledgement to TX in step 8. At step 9, TS initiates the creation or updating of a campaign by sending a message to DS. This message may be used to create a new campaign or complete a campaign. DS sends an acknowledgement to TS in step 10.

In step 11, scheduling of the campaign to the user(s) occurs. In one optional embodiment, if an end/start date for the campaign is present, a scheduler is created with the end date. The end and start dates may be sent by the CRM, e.g. at step 4. In another optional embodiment, no end date is present for recalls. In order to end a recall campaign, the CRM sends another campaign having the proper end date.

The campaign is executed by having the control center's telematics system send the campaign to the gateway in step 12. An acknowledgement is sent to from the gateway to the TS at step 13. The campaign is delivered to vehicle(s) of the device network in step 14.

Priorities may be assigned for different types of campaigns. In one embodiment, a highest priority of ‘0’ is given to a “Welcome” campaign. Recall campaigns are assigned a priority of ‘1’. “DTC” campaigns are given a priority of ‘2’. In one embodiment a “High DTC” campaign is assigned a priority of ‘1’. “Maintenance” campaigns are assigned a priority of ‘3’. “Service” campaigns, e.g. all marketing campaigns other than a “Welcome” campaign are assigned a lowest priority of ‘4’.

In one embodiment, before executing step 14, the gateway checks to determine whether an open high priority campaign exists. If the campaign already exists, no message needs to be sent to the device. If the campaign does not exist, steps 12-14 are executed.

At step 15, a campaign execution acknowledgement initiated from the device is sent from the device(s) to the gateway. At gateway. At step 16, a process report is sent from the gateway to the TS.

At step 17, TS receives a trigger from the scheduler to end the campaign. In one embodiment, a cancel campaign process is used at the TS to turn off a flag on the vehicle device.

If an error occurs, a notification can optionally be sent from the TS to the CRM at step 18. The CRM, in turn, will update the bridge. The notification message sent at step 18 may include a campaign contact identifier, a campaign identifier, a status, a source, a campaign category, and an error message.

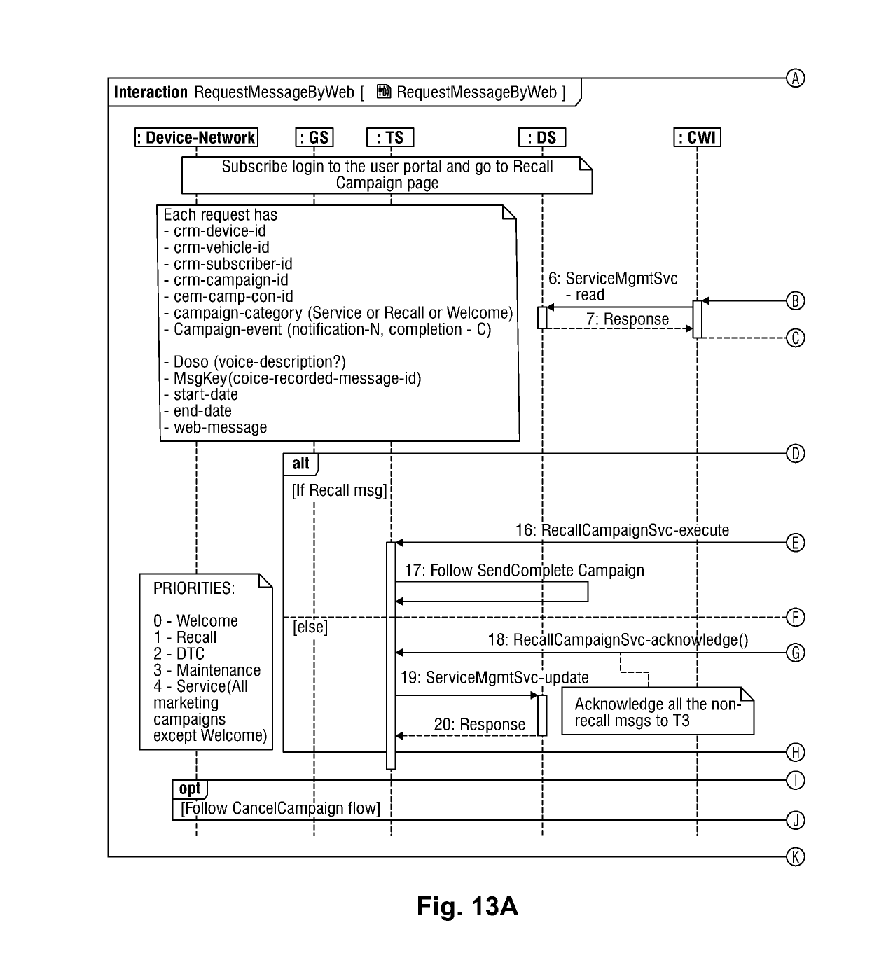

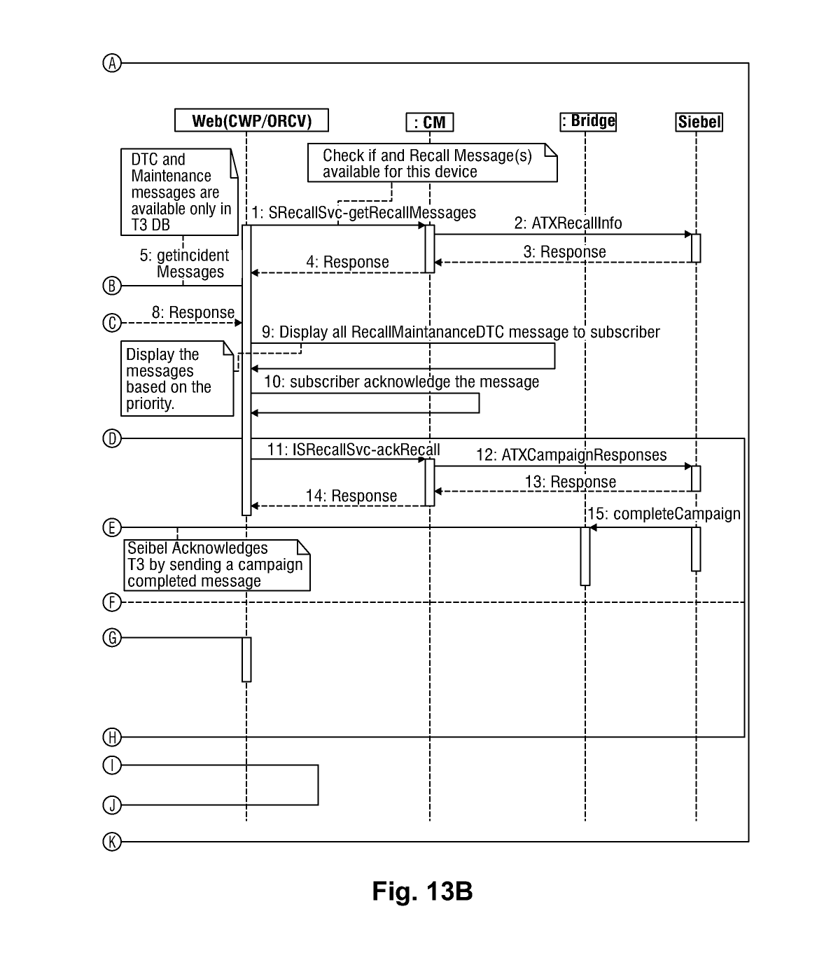

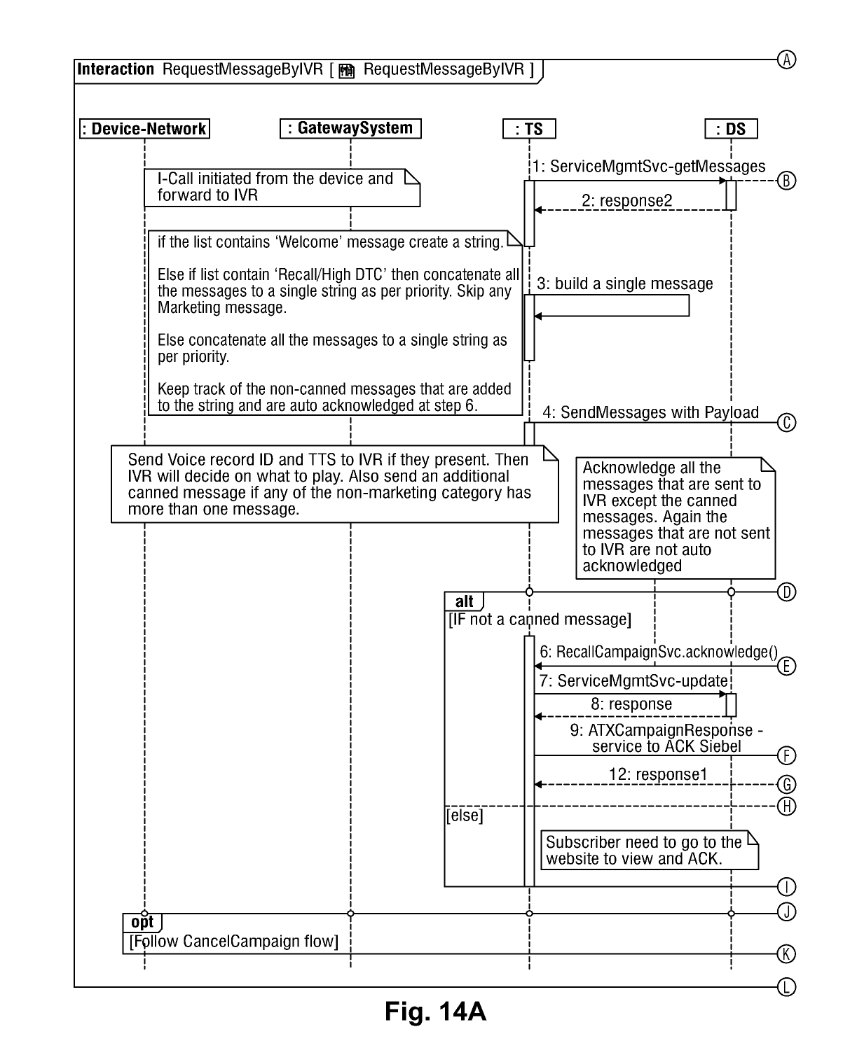

The flow diagram in FIG. 13 illustrates how the systems and processes work to deliver campaign messages including the Web. Here, the “CWI” is a gateway between the telematics platform and the Internet. “CM” is a gateway that allows the Siebel CRM system to be exposed to the Internet. The “Web(CWP/ORCV)” or the “CWP” is the systems and processes that communicate with the CM to get subscriber data from Siebel and also obtains T3 data from CWI.

A subscriber logs in to a user portal via the Internet and goes to a recall campaign page. The CWP send a message to the CM to determine if any recall messages are available for the subscriber's device(s) in step 1. At step 2, the CM sends a message to the CRM to determine if there is any recall information. At step 3, a response is sent from the CRM to the CM Likewise, at step 4, a response is sent from the CM to the CWP. The responses sent at steps 3 and 4 may include a recall message or recall information.

At step 5, the CWP requests incident messages from the CWI. DTC and maintenance messages are available only in the T3 database. At step 6, the CWI sends a request to read campaign messages to the DS. The DS sends a response to the CWI in step 7. The CWI, in turn, sends a response to the CWP in step 8. The responses sent at steps 7 and 8 may include DTC and maintenance message information

Each request (e.g. message) may include a device identifier, a vehicle identifier, a subscriber identifier, a campaign identifier, a campaign contact identifier, a campaign category, a campaign event field, a description field, a message identifier, a start date, an end date, and a web message. The device identifier is present in every request, however, other information that may be included in each request is optional.

At step 9, all recall, maintenance, and/or DTC messages are displayed to the subscriber via the web interface, e.g., a user portal. In one embodiment, messages are displayed based on their priority. Priorities may be assigned for different types of campaigns. In one embodiment, a highest priority of ‘0’ is given to a “Welcome” campaign. Recall campaigns are assigned a priority of ‘1’. “DTC” campaigns are given a priority of ‘2’. In one embodiment a “High DTC” campaign is assigned a priority of ‘1’. “Maintenance” campaigns are assigned a priority of ‘3’. “Service” campaigns, e.g. all marketing campaigns other than a “Welcome” campaign are assigned a lowest priority of ‘4’. At step 10, the subscriber acknowledges the message.

Steps 11 to 17 describe processing that occurs when there is a recall message. When the subscriber acknowledges that there is a recall message, the web interface sends an acknowledgement to the CM in step 11. At step 12, the CM queries the CRM for a recall campaign response. At step 13, the CRM sends a response to the CM. The CM in turn sends a response to the web interface in step 14. The responses sent at steps 13 and 14 may include a recall message or recall information.

At step 15, the CRM acknowledges the T3, e.g. TS, by sending a campaign completed message to the bridge. The bridge, in turn, sends a message to the TS to execute the campaign at step 16. At step 17, TS may either send the campaign to the device or remove the campaign from the device.

Steps 18 to 20 describe processing that occurs when there is no recall message. At step 18, the web interface sends an acknowledgement of all non-recall messages to the TS. At step 19, if there is an update to any of the messages, the TS sends an update message to the DS. At step 20, the DS sends a response to the TS. The response is an acknowledgement of any updated messages.

In one embodiment, a campaign flow can be canceled. For example, the user can opt out of a campaign or a campaign can be canceled via the system.

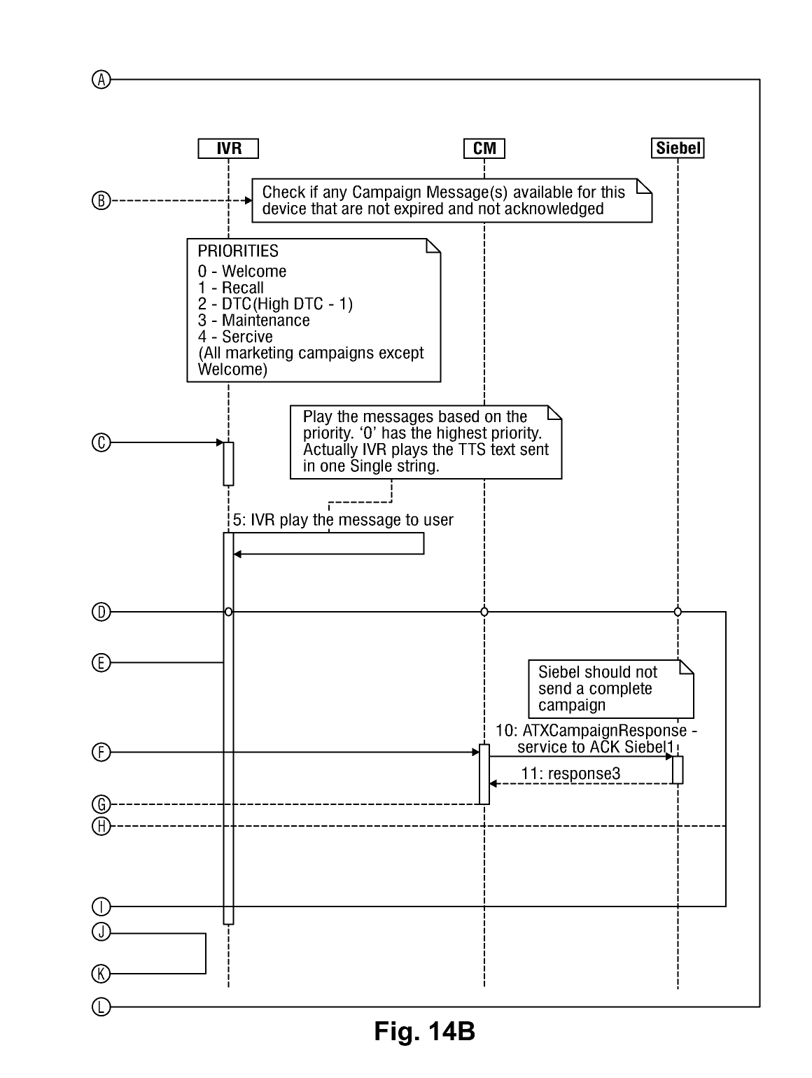

The flow diagram in FIG. 14 illustrates how the systems and processes handle a campaign when a request arrives from a vehicle. A call is initiated from the device and forwarded to the IVR. At step 1, the TS sends a request to the DS to check whether any campaign message(s) is/are available for the device that are not expired and not acknowledged. The DS sends a response to the DS in step 2. At step 3, the TS builds a single message. At step 4, the campaign messages are sent by the TS to the IVR in the payload of the message built in step 3.

At step 5, the IVR plays the campaign message(s) to the user. In one embodiment, if the message(s), e.g. a list of messages, contain a Welcome message, a separate string is created for the Welcome message. In one embodiment, if the list of messages contains Recall or High DTC messages, all of the messages are concatenated to a single string based on a priority and any marketing messages are skipped. In one embodiment, messages are concatenated to a single string as per assigned priority when the messages are comprised of DTC, Maintenance, and/or Service related messages.

In one embodiment, when there are multiple messages, the messages are played based on a priority. In one embodiment, a highest priority of ‘0’ is given to a “Welcome” campaign. Recall campaigns are assigned a priority of ‘1’. “DTC” campaigns are given a priority of ‘2’. In one embodiment a “High DTC” campaign is assigned a priority of ‘1’. “Maintenance” campaigns are assigned a priority of ‘3’. “Service” campaigns, e.g. all marketing campaigns other than a “Welcome” campaign are assigned a lowest priority of ‘4’.

At step 6, with the exception of canned messages, all messages sent to the IVR by the TS are acknowledged by the IVR. In one embodiment, the TS keeps track of non-canned messages that are added to the string and are auto-acknowledged at step 6. At step 7, an update request is sent from the TS to the DS. At step 8, a response is sent from the DS to the TS. At step 9, the TS sends an acknowledgement message to the CM. At step 10, the CM forwards the acknowledgement to the CRM. At step 11, a response is sent from the CRM to the CM. In one embodiment, the CRM does not send a complete campaign. A CRM may not send a complete campaign in some instances because, in some cases, the message length is prohibitive for in-vehicle communication. In such a case, the customer is redirected to a more appropriate medium to receive the entire message. At step 12, the CM, in turn, sends a response to the TS. The responses or acknowledgements in steps 6-12 are used to convey that the message has been received.

In one embodiment, the TS sends a voice record and TTS information received from the device to the IVR. Based on the voice record and TTS information, the IVR decides what messages to play. An additional canned message can be sent if any of the non-marketing categories has more than one message. When there are additional canned messages, the user needs to receive and acknowledge the detailed messages. The subscriber needs to view and acknowledge these detailed messages via the website, e.g. web portal or a personal device.

In one embodiment, a campaign flow can be canceled. For example, the user can opt out of a campaign or a campaign can be canceled via the marketing system based on change of location or other criteria.

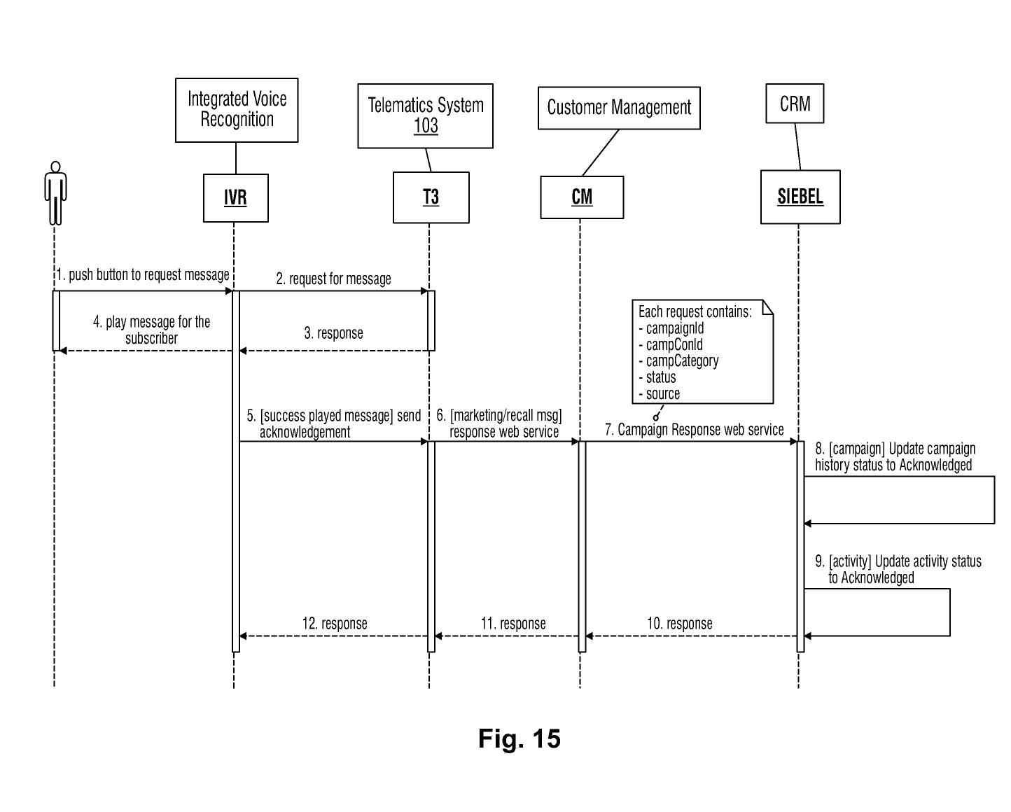

The flow diagram in FIG. 15 is another illustration of how the systems and processes handle a campaign when a request arrives from within a vehicle. At step 1, a subscriber pushes a button to request a message, for example, using a device in a vehicle. This request is sent to an IVR. At step 2, the IVR sends a request for a message to T3, e.g. telematics system 103. At step 3, T3 sends a response to the IVR. At step 4, the IVR plays the message for the subscriber. If the message is successfully played, an acknowledgement is sent from IVR to T3 at step 5. In one embodiment, if the message is a marketing or recall message, a response is sent from the telematics system to the web service, e.g. customer management (CM) interface, at step 6. At step 7, the CM sends a campaign response to the CRM. Each request, e.g. campaign response message, may include a campaign identifier, a campaign contact identifier, a campaign category, a status, and a source. At step 8, a campaign history is updated to a status of Acknowledged by the CRM. At step 9, an activity status is updated to a status of Acknowledged by the CRM. At step 10, a response is sent from the CRM to the CM. At step 11 a response is sent from the CM to the T3. In turn, a response is sent from T3 to the IVR at step 12. The responses in steps 10-12 are acknowledgements that the noted activity actually took place.

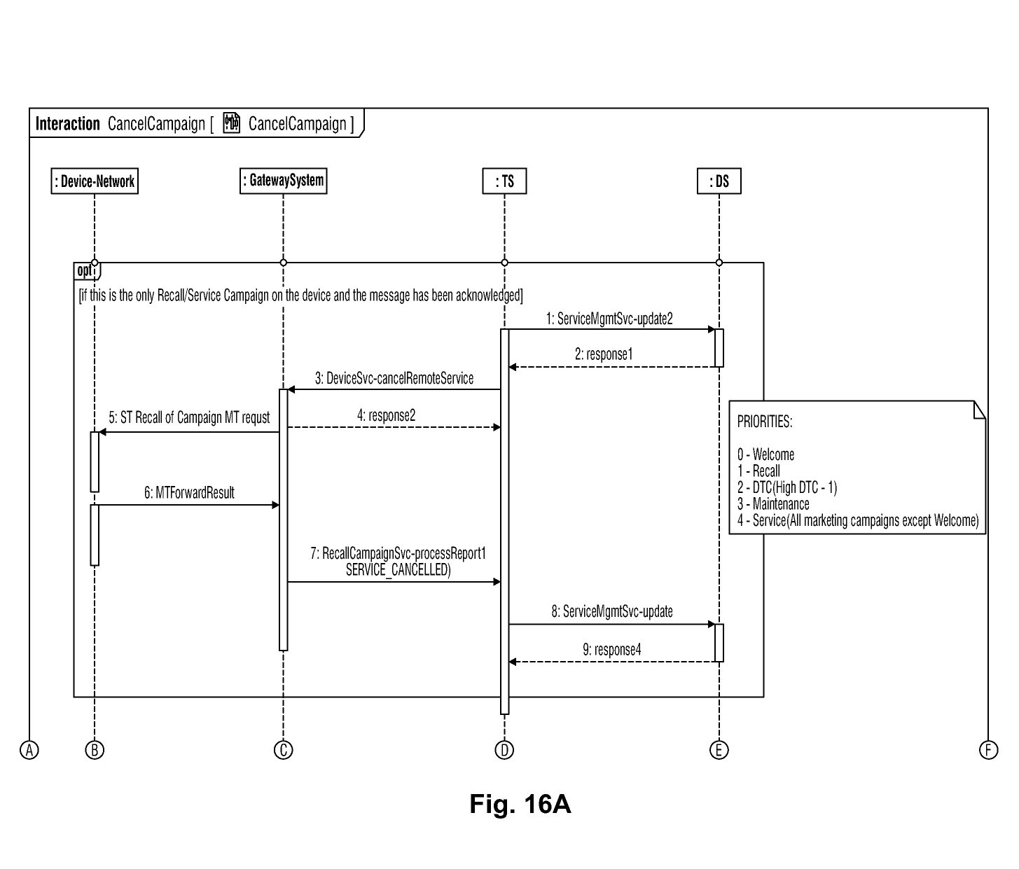

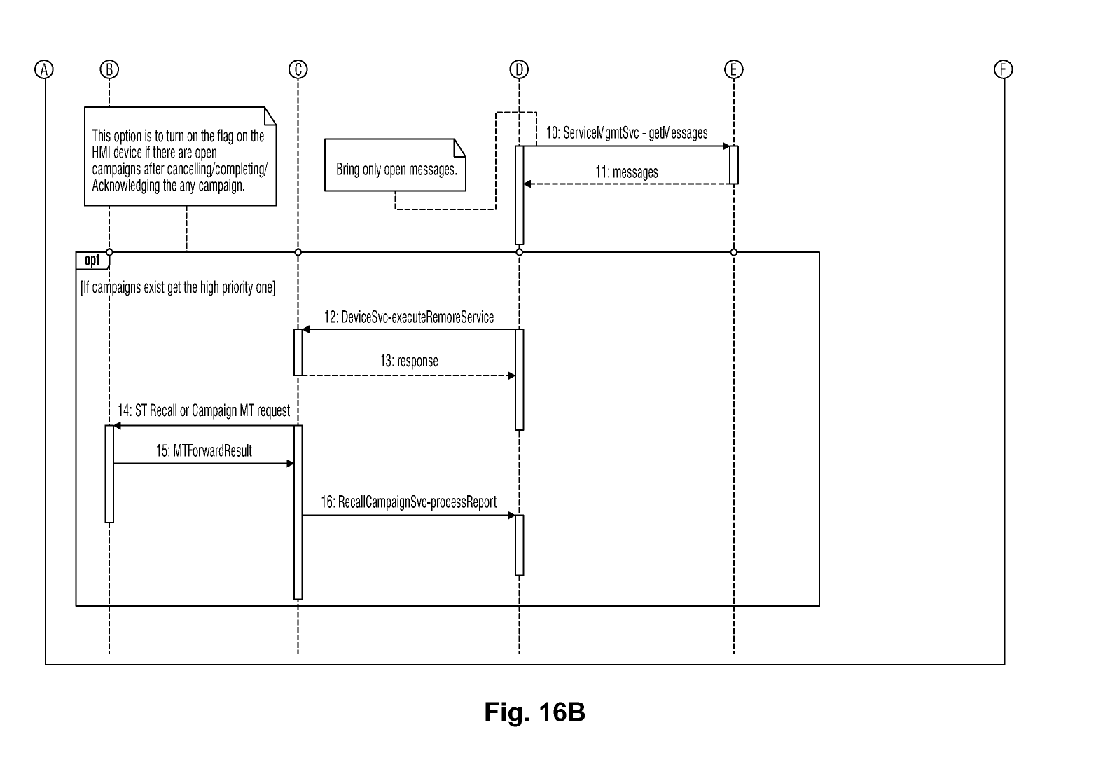

The flow diagram in FIG. 16 illustrates how the systems and processes handle the cancellation of a campaign from within the telematics platform. FIG. 16 illustrates two optional processes. The first process occurs when a message has been acknowledged for the only Recall/Service campaign on the device. At step 1, the TS sends an update request to the DS.

The DS responds to the TS in step 2. At step 3, the TS sends a request to cancel a campaign to the gateway. The gateway responds to the TS at step 4. At step 5, the gateway sends a request to cancel the campaign to the device. The device forwards an acknowledgement that the recall campaign has been canceled to the gateway in response to the request at step 6. At step 7, the gateway forwards an indication that the service has been cancelled to the TS. At step 8, the TS sends an update to the DS. A response, e.g., an acknowledgement of the update, is sent from the DS to the TS at step 9.

At step 10, the TS sends a request to the DS to get messages. In one embodiment, only open messages are requested. At step 11, the DS sends the messages to the TS.

The second process turns on a flag on an HMI device if there are open campaigns after the cancellation/completion/acknowledgement of any campaign. If campaigns exist, the high priority campaign is retrieved. As stated previously, the messages/campaigns can be played based on a priority. In one embodiment, a highest priority of ‘0’ is given to a “Welcome” campaign. Recall campaigns are assigned a priority of ‘1’. “DTC” campaigns are given a priority of ‘2’. In one embodiment a “High DTC” campaign is assigned a priority of ‘1’. “Maintenance” campaigns are assigned a priority of ‘3’. “Service” campaigns, e.g. all marketing campaigns other than a “Welcome” campaign are assigned a lowest priority of ‘4’. At step 12, the TS sends a request to execute a remote service to the gateway. At step 13, the gateway sends a response to the TS. At step 14, the gateway sends a request to the device. At step 15, the device forwards a result to the gateway. The result forwarded at step 15 is acknowledgement that remote service has been executed by the device. At step 16, the gateway sends a process report to the TS.

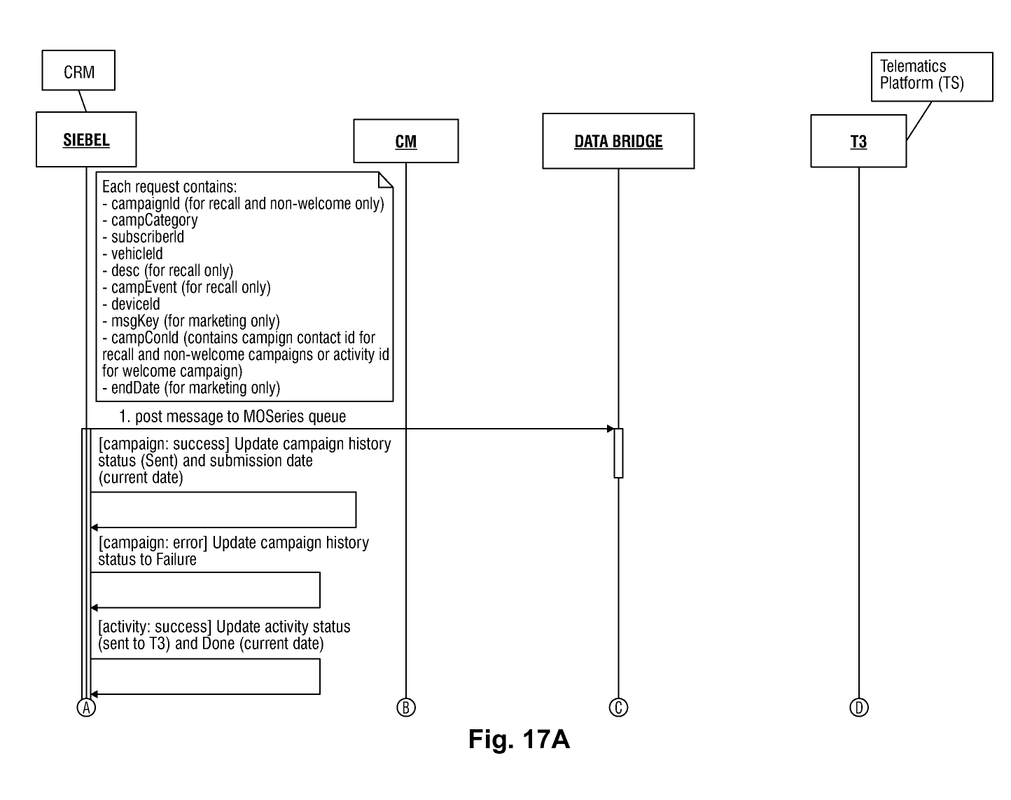

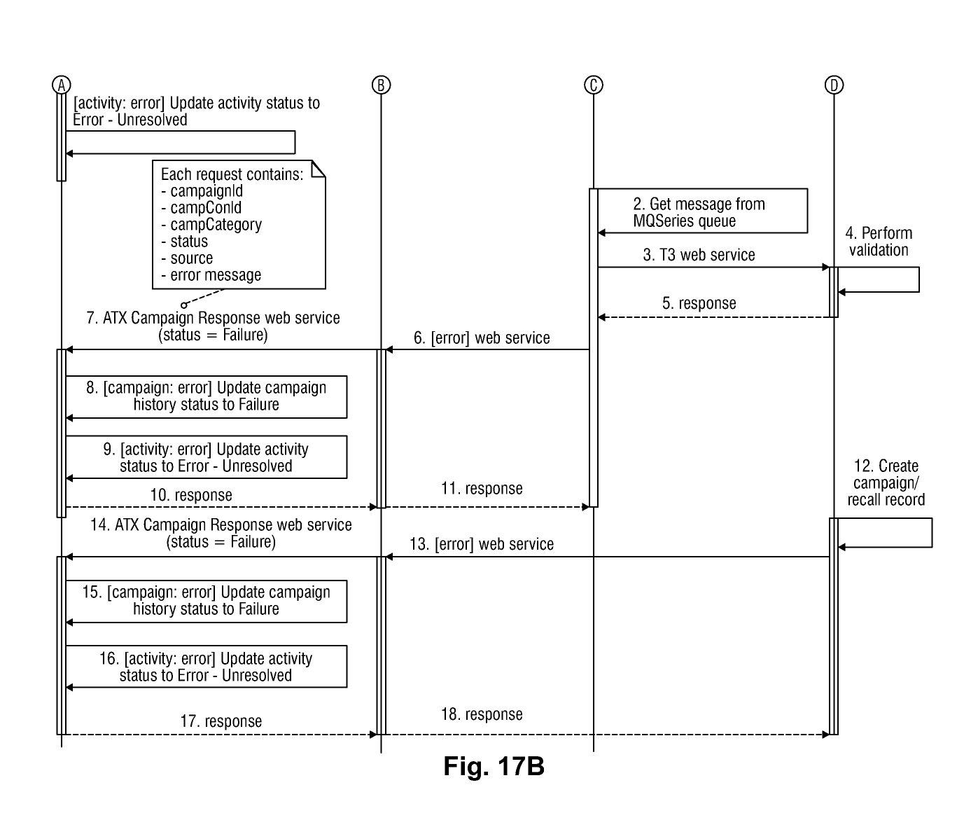

The flow diagram in FIG. 17 illustrates how the systems and processes handle internal processing of a campaign from within the control center. At step 1, the CRM posts a message to a queue at the data bridge. Each message, e.g., request, may contain a campaign identifier, a campaign category, a subscriber identifier, a vehicle identifier, a description, a campaign event, a device identifier, a message key, a campaign contact identifier, an activity identifier, and an end date. A campaign identifier is included in the request only for recall and non-welcome messages. A description is only included in the request for recall messages. Likewise, a campaign event is included only for recall messages. A message key is included in the request only for marketing messages. The campaign contact identifier is included only for recall and non-welcome campaigns. The activity identifier is included only for welcome campaigns. An end date is included only for marketing messages.

In one embodiment, the CRM sets statuses for campaigns and activities. When a campaign has a status of “success”, a campaign history status is updated to “sent” status and a submission date is updated to the current date. When a campaign has a status of error, a campaign history status is updated to “failure” status. When an activity has a status of “success”, an activity status is updated to “sent to T3” and a Done status is updated to the current date. When an activity has a status of error, an update activity status is updated to a status of “Error-Unresolved”.

At step 2, the data bridge retrieves the posted message. At step 5, the data bridge initiates a web service with T3. At step 4, the T3 performs a validation. At step 5, the T3 sends a response to the data bridge. At step 6, the data bridge indicates that an error has occurred to the CM via the web service. At step 7, the CM sends a response to the CRM via the web service indicating a failure status. At step 8, the CRM updates the campaign history status to “failure”. At step 9, the CRM updates an activity status to “Error-Unresolved”. At step 10, the CRM sends a response to the CM. At step 11, the CM sends a response to the data bridge.

At step 12, the T3 creates a campaign/recall record. At step 13, the T3 sends an error message to the CM via the web service. At step 14, the CM sends a response indicating a status of failure to the CRM via the web service. At step 15, the CRM updates a campaign history status to “failure”. At step 16, the CRM updates the activity status to “Error-Unresolved”. At step 17, the CRM sends a response to the CM. At step 18, the CM in turn sends a response to the T3.

As an additional example, criteria-based audio messages may be triggered based on seasonal changes. As just one example, many vehicles need special attention before winter begins, depending on their location of use. Upon pressing the button 112, a message may be played that announces a particular business's products, e.g., snow tires, that are specific to a season (a first criteria) and the type of vehicle (a second criteria). Many other criteria can be utilized as well, such as the vehicle's normal driving area (determined via GPS 107), previous purchases or services performed on or to the vehicle, and many others.

As a further example of the advantageous features of the present invention, suppose a car salesperson is showing a vehicle to a potential buyer and wishes to demonstrate the advantageous feature of telematics system equipped on the vehicle. The salesperson can instruct the potential buyer to press the button 112, which initiates a call to the control center 200, which, in turn, determines whether or not the particular car is currently subscribed to the service (a criteria). If the unit is not identified as a currently subscribing vehicle, the control center 200 can initiate a demonstration service example in an effort to both educate the potential buyer, as well as entice the buyer to purchase the vehicle and also to subscribe to the inventive service. The following is an exemplary service example that can take place and educate as well as entertain the potential purchaser, or anyone else listening to the advertising message. It is noted that the following example dialogue between two people is merely an example of a prerecorded dialogue and that the potential purchaser or any other person at the vehicle side are listening to and are not participating in the dialogue.
Female voice: Telematics service center. How may we be of assistance?
Male voice: Today is my anniversary and I would like to have flowers delivered to my wife.
Female voice: Happy anniversary! I can certainly help you with that. What type of flowers were you looking for and where would you like them delivered.
Male voice: I was thinking of a dozen long stem roses. My wife's address at work is 3232 Main Street, Suite 123, so if they could be delivered before she leaves at 6:00 p.m., that would be great. Her name is Susie Smith.
Female voice: No problem Mr. Smith. I have located a flower shop near this address. When we finish this call, I will connect you directly with the shop. Is there anything else I can help you with?
Male voice: There is. I would like to take her to a nice dinner tonight. What are some good restaurants downtown?
Female voice: I have located quite a few highly rated restaurants in that area, what type of food are you looking for?
Male voice: A good steak restaurant sounds nice.
Female voice: I have located Restaurant X, which received five stars in our latest restaurant review. Would you like me to make reservations for you?
Male voice: Yes, please. I would like them for 7:00 p.m.
Female voice: Please hold for a second. Okay, your reservations have been made and are under your name. Would you like to have a bottle of Champagne on ice at the table when you arrive?
Male voice: Wow, that would be great!
Female voice: I will take care of that for you. Is there anything else I can help you with today?
Male voice: No, thank you so much.
Female voice: It was our pleasure. I will now connect you with the flower shop. Have a great evening!

The service example, such as the one above, is believed to be much more interesting to the listener than a simple prerecorded description of available features, which tend to be monotonous and lacking in emotion. The above exemplary dialogue is not limited to potential purchases and can be played to owners of cars equipped with the present invention whether they are subscribers or not. In one exemplary embodiment, the invention can provide a system for tracking service examples or descriptions that have been demonstrated and ensures that these same advertising messages are not repeated to the same vehicle or vehicle driver. The prerecorded service examples are an advantageous way to educate subscribers or non-subscribers of the types of services available. The examples allow dialogues to be played out without requiring live operators to speak to each person. However, the invention is in no way limited to pre-recorded messages and, in some cases, live operators can perform the service examples. It is envisioned that, prior to subscribing to the service, only pre-recorded messages will be available to the driver.

As previously stated, when delivering criteria-based messages, it is believed that service examples are more attractive to listeners and more effective at conveying a service's features. In addition, when considering potential audio prompts that a listener hears when using an automated voice application, one goal has been to make the user's experience better by completing the caller's task in a time-efficient manner, making it less likely that a caller will request a conversation with a human. Over time, automated applications have become more human-like with signs of reaching natural language. Callers can even relate to an automated “persona,” as speech vendors have been calling the implied personality of the automated system. There is an opportunity to involve the caller emotionally, even to entertain by humor, for example, and to make the call a pleasant experience. Even if a dialogue designer does not attempt to create human-like qualities, the caller will intuitively assign them to the automated persona. If used properly, this characteristic can make audio messages to the vehicle very effective.

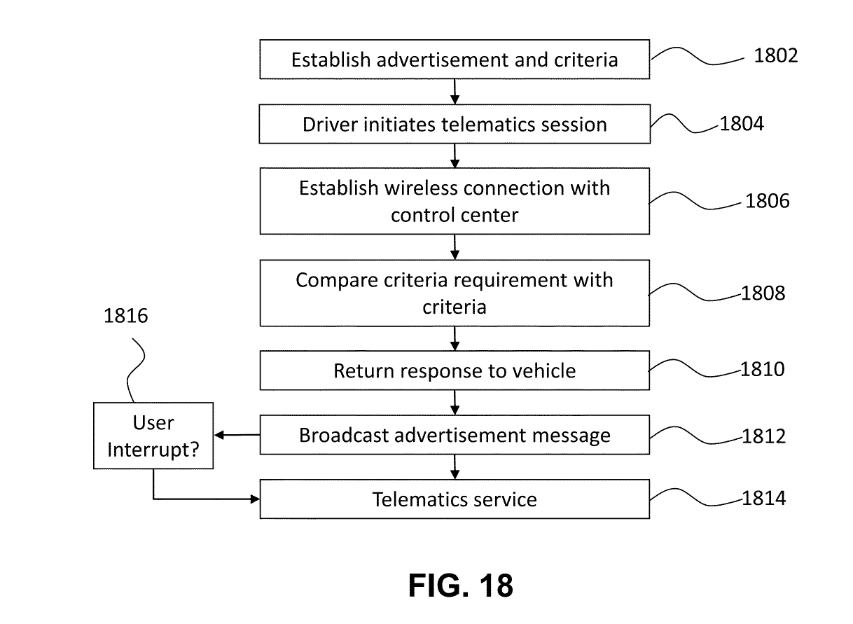

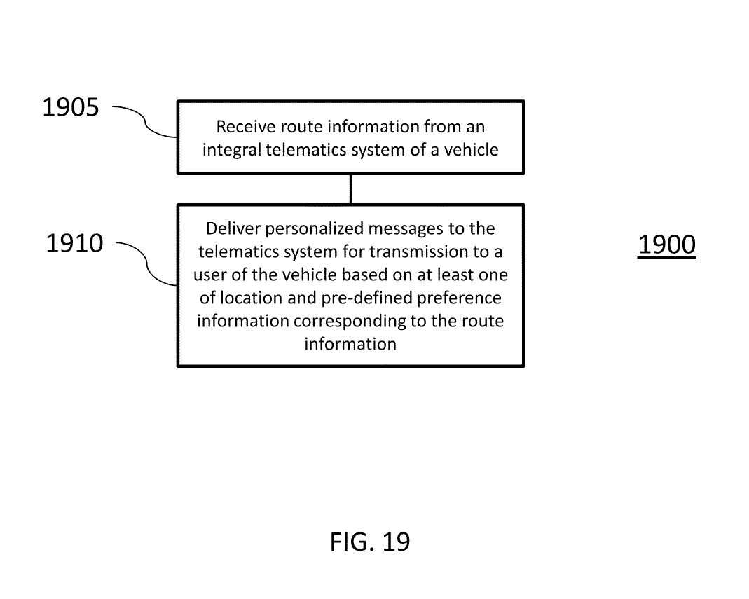

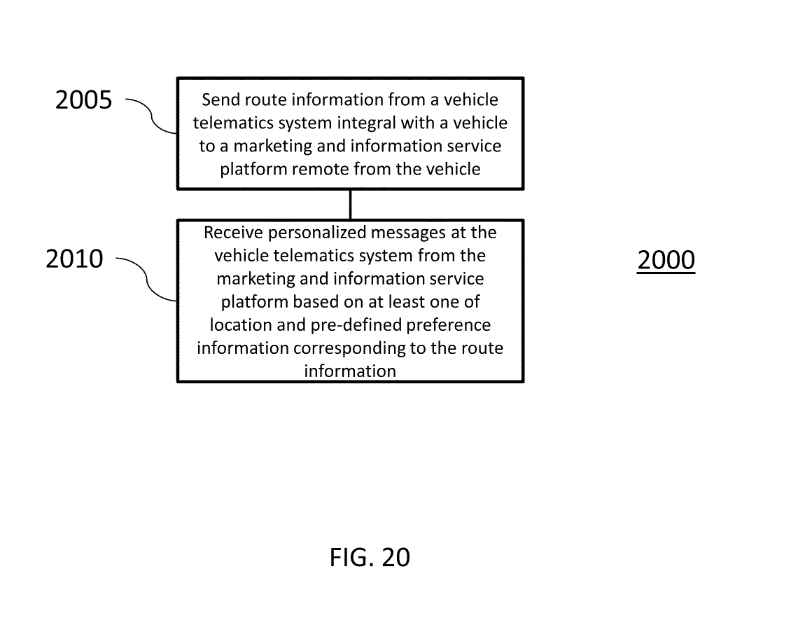

FIG. 18 shows an exemplary process for performing the inventive method when an advertisement with criteria is created in the system and the driver initiates a telematics session, as in the example of FIG. 14. The process starts at step 1802 where at least one advertisement is established, the advertisement having at least one criteria requirement associated therewith. “Establishment” can mean the actual recording of the advertisement and the “criteria requirement” can indicate factors that determine who is to hear the recorded message and when they should hear it. The criteria requirement includes prerequisite statistics that are to be met before the advertisement should be transmitted to a particular vehicle. In step 1804, a driver 101 initiates a telematics feature within a vehicle 100. For instance, the driver 101 can press the button 112 within the car. In step 1806, the in-car equipment initiates a communication session over a wireless link 212 to the remote control center 200. Included in this communication of step 1806 is the transmission to the remote control center 200 of at least one statistic pertaining to at least one criteria. This includes, for example, information pertaining to the vehicle to which the equipment is attached, the vehicle's location, whether the driver is a subscriber or not, and many others. In step 1808, the remote control center 200 compares the at least one criteria requirement associated with the advertisement to the at least one statistic. Based on this comparison, the control center returns a response to the vehicle 100 in step 1810. The response, in one embodiment, is an automatically determined advertising message based on one or more of the identified criteria and associated statistics. The message, for instance, is an advertising message attempting to persuade the listener to take an action. In step 1812, the advertisement message is broadcast to the vehicle. In step 1814, after the criteria-based message has finished playing in step 1812, the system allows the driver 101 to carry out his or her desired use of the telematics service. At any time during step 1812, the user can interrupt the playing of the message (e.g., push a button (step 1816)) and the process will immediately jump to step 1814.

Systems and processes for delivering criteria-based audio messages through a wireless connection to a vehicle have been described. The present invention delivers audio messages that are stored off-board, and are triggered by conditions related to criteria, such as time, vehicle location, an event, a condition, a mood-influencing intent, a tourist attraction, or service reminders. The criteria-based messages are controlled by an automated voice recognition system located at a remote data center and delivered via a wireless voice or data channel to the vehicle. The vehicle driver and/or passengers hear the audio message under various driving conditions. A voice user interface is utilized by the vehicle driver to manage the audio messages. The invention further includes methodology for pushing audio messages to a vehicle in a highly controlled fashion and in a way that does not interfere with the task of driving. The present invention further includes techniques for designing audio messages that match the intent associated with the criteria required to trigger the deliverer of the audio message.

FIG. 19 is a diagram illustrating a method 1900 for providing marketing materials from a marketing and information service platform, e.g. platform 900, to a vehicle telematics system. At item 1905, route information in received from an integral telematics system of a vehicle. At item 1910, personalized messages are delivered to the telematics system for transmission to a user of the vehicle based on at least one of location and pre-defined preference information corresponding to the route information. The route information may be a location of the vehicle or user device on the route selected and followed by the vehicle or user device.

A targeted marketing message can be presented to the customer via an in-vehicle system or other personalized communication device, e.g., a tablet or smartphone, where the location of the vehicle or personal device is in close proximity to a POI that is directly associated to the marketing message or offer. The marketing and information service platform is location aware and user profile aware in its delivery of the targeted message or special offer, e.g., coupon. This POI can be associated with the pre-selected route within the vehicle or saved to a user profile for use when a user approaches the POI on foot.

In one embodiment, marketing and information services platform, e.g., platform 900, is operable to provide marketing materials to the vehicle telematics system 103 based on the location of the vehicle 100. In these exemplary embodiments, the control center 200 is operable to read routes calculated by an in-vehicle navigation system, and, based on the current GPS coordinates (identified by the GPS component 107), predefined customer POI preferences along the route, and/or the time of day, the control center 200 delivers a personalized message to the driver 101 through a pre-selected mode of communication. Examples of modes of communication include text messages, in-vehicle audio messages, images on an in-vehicle display, email messages, or a web site account. Pre-defined customer POI preferences may be configured using an off-board web portal 300 in communication with the control center 200.

In one embodiment, the personalized messages are aggregated. The criteria-based messaging system is operable to aggregate content from various POIs and, based on customer profiles, assign a relevancy, e.g. priority, to the content. In other words, the system can filter targeted messages from various POIs, by assigning a relevancy to the targeted messages based on predefined user preferences, and send only those messages with a higher relevancy, i.e., greater preference, to the vehicle 100 associated with a particular user profile.

The user may be redirected to a different communication channel to consume the aggregated messages. For example, the user can be provided an option to access a web site or smart phone application in order to retrieve detailed messages. In this case, the user is informed of pending messages and provided options on the best way to receive and consume the messages.

In one embodiment, personalized messages are sent based upon a user permission setting. The driver 101 can set permissions regarding the receipt of the above-described targeted marketing messages. In other words, he or she can opt-in or opt-out to receiving such messages.

In one embodiment, the personalized messages are based upon social networking application data. In some cases, personalization of messages can be based on social networking preference or public profile data. For example, a user arrives at a POI that is associated with their FOURSQUARE® account and, upon check-in, receives a special promotion from the marketing system. In addition, the vehicle operator 101 could integrate his/her web portal 300 account with his/her favorite social networking applications 1100 (at block 1140) to leverage areas of interest such as FACEBOOK® Places (POI type) or FOURSQUARE® shared through mutual friends and purchase propensity affiliations from GROUPON® or other such social services that identify the intersection of location and product purchase interests along a given route where proximity and timing are key relevance criteria. The ability for the marketing system 900 to pull social network data, and, if needed, user account data, from social networking sites 1100 makes it relevant and location-aware while driving, which is very desirable to a vehicle operator 101.

In one embodiment, the personalized messages can be dynamically calculated. The dynamically calculating algorithm formulates a result based on at least a change of location (in-route) and customer user profile data. The control center 200 can dynamically calculate personalized campaign messages, which can be modified on the fly through direct, e.g., in-vehicle, customer feedback, and update the marketing and information services platform 900 to redefine future personalized campaign messages. The key data points upon which the marketing campaign algorithm can be based are, for example, cost of the vehicle owned, neighborhood of principle garaging, and market value of primary residence. Any other data that the system may be able to obtain from outside sources can also be included as a data point for the marketing campaign algorithm.

In one embodiment, the personalized messages are presented based on a history of requested point of interest searches. The criteria-based messaging system uses the history of driver requested POI searches to determine the most frequently visited POI locations, which information is used to present targeted marketing campaign messages. For this purpose, the criteria-based messaging system may incorporate a tracking system. For those POI locations that provide information regarding services offered, targeted messages can be dynamically supplied directly to the driver 101. For example, a history of driver requested POI searches reveals that the driver frequently visits restaurant A. Accordingly, the marketing and information services platform 900 delivers messages regarding promotions at restaurant A to the vehicle 100 because it knows, based on the tracked POI history, that the driver 101 has a particular preference for restaurant A. Upon receiving a campaign message from restaurant A, the driver 101 may opt to hear additional information such as lunch or dinner menu options based on the time of day and proximity to the location while in route within the vehicle. The driver 101 may further be able to make a reservation at restaurant A through the communications with the control center 200.

FIG. 20 is a diagram illustrating a method 2000 for providing marketing materials from a marketing and information services platform to a vehicle telematics system. At item 2005, route information is sent from the vehicle telematics system integral with the vehicle to the marketing and information service platform remote from the vehicle. At item 2010, personalized messages are received at the vehicle telematics system from the marketing and information service platform based on at least one of location and pre-defined preference information corresponding to the route information.

In one embodiment, marketing materials can be provided to vehicle telematics system 103 from marketing and information services platform, e.g., platform 900, based on the location of the vehicle 100. In these exemplary embodiments, routes calculated by an in-vehicle navigation system are sent to control center 200, and, based on the current GPS coordinates (identified by the GPS component 107), predefined customer POI preferences along the route, and/or the time of day, the driver 101 receives a personalized message from control center 200 through a pre-selected mode of communication. Examples of modes of communication include text messages, in-vehicle audio messages, images on an in-vehicle display, email messages, or a web site account. Pre-defined customer POI preferences may be configured using an off-board web portal 300 in communication with the control center 200.

In one embodiment, personalized messages are sent based upon a user permission setting. The driver 101 can set permissions regarding the receipt of the above-described targeted marketing messages. In other words, he or she can opt-in or opt-out to receiving such messages.

In one embodiment, the personalized messages are based upon social networking application data. In some cases, personalization of messages can be based on social networking preference or public profile data. For example, a user arrives at a POI that is associated with their FOURSQUARE® account and, upon check-in, receives a special promotion from the marketing system. In addition, the vehicle operator 101 could integrate his/her web portal 300 account with his/her favorite social networking applications 1100 (at block 1140) to leverage areas of interest such as FACEBOOK® Places (POI type) or FOURSQUARE® shared through mutual friends and purchase propensity affiliations from GROUPON® or other such social services that identify the intersection of location and product purchase interests along a given route where proximity and timing are key relevance criteria. The ability for the marketing system 900 to pull social network data, and, if needed, user account data, from social networking sites 1100 makes it relevant and location-aware while driving, which is very desirable to a vehicle operator 101.

In one embodiment, dynamically calculated personalized messages can be received at the vehicle telematics system or user device. Personalized campaign messages received by the vehicle telematics system or user device can be modified on the fly through direct, e.g., in-vehicle, customer feedback. This direct customer feedback can be sent to the marketing and information services platform so that the platform, e.g., platform 900, can redefine future personalized campaign messages based on the feedback.

In one embodiment, the route information is sent to the marketing and information services platform via a cellular network. In one embodiment, the personalized messages are received via at least one of a cellular network and the Internet.

The communication connection between the vehicle telematics system 103 and the marketing and information services platform 900 can be through a cellular network 920. Alternatively, the communication connection between the vehicle telematics system 103 and the marketing and information services platform 900 can be similar to the communication connection shown and described with respect to FIGS. 1 and 2. In addition to receiving marketing messages via network 920 at vehicle telematics system 103, marketing messages may be received at devices 1005, 1010, 1015 via the internet, e.g., as shown in FIG. 10.

Although the foregoing specific details describe preferred embodiments of this invention, persons reasonably skilled in the art of wireless data communication and/or voice recognition technology will recognize that various changes may be made in the details of the method and apparatus of this invention without departing from the spirit and scope of the invention as defined in the appended claims. Therefore, it should be understood that this invention is not to be limited to the specific details shown and described herein. The above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for providing marketing materials from a marketing and information service platform to a vehicle telematics system, comprising:
receiving route information from an integral telematics system of a vehicle; and
delivering personalized messages to the telematics system for transmission to a user of the vehicle based on at least one of location and pre-defined preference information corresponding to the route information.

2. The method according to claim 1, which further comprises delivering the personalized messages based upon a time of day.

3. The method according to claim 1, wherein the route information comprises current global positioning system (GPS) coordinates identified by a GPS component of the telematics system.

4. The method according to claim 1, which further comprises delivering the personalized messages through a pre-selected mode of communication.

5. The method according to claim 1, which further comprises aggregating the personalized messages.

6. The method according to claim 5, which further comprises delivering the personalized messages based on an assigned relevancy.

7. The method according to claim 1, which further comprises sending the personalized messages based upon a user permission setting.

8. The method according to claim 1, wherein the personalized messages are based upon social networking application data.

9. The method according to claim 1, which further comprises dynamically calculating the personalized messages.

10. The method according to claim 9, which further comprises modifying the personalized messages on the fly through direct in-vehicle customer feedback.

11. The method according to claim 1, which further comprises presenting the personalized messages based on a history of requested point of interest searches.

12. A method for providing marketing materials from a marketing and information services platform to a vehicle telematics system, comprising:
sending route information from the vehicle telematics system integral with a vehicle to the marketing and information service platform remote from the vehicle; and
receiving personalized messages at the vehicle telematics system from the marketing and information service platform based on at least one of location and pre-defined preference information corresponding to the route information.

13. The method according to claim 12, which further comprises receiving the personalized messages based upon a time of day.

14. The method according to claim 12, wherein the route information comprises current GPS coordinates identified by a GPS component of the telematics system.

15. The method according to claim 12, which further comprises receiving the personalized messages through a pre-selected mode of communication.

16. The method according to claim 12, which further comprises receiving the personalized messages based upon a user permission setting.

17. The method according to claim 12, wherein the personalized messages are based upon social networking application data.

18. The method according to claim 12, which further comprises sending direct in-vehicle customer feedback to the marketing and information services platform.

19. The method according to claim 12, which further comprises sending the route information to the marketing and information services platform via a cellular network.

20. The method according to claim 12, which further comprises receiving the personalized messages via at least one of a cellular network and the Internet.
